(19) United States
(12) Patent Application Publication
(10) Pub. No.: US 2026/0182816 A1
(43) Pub. Date: Jul. 2, 2026

(54) DIRECT SPRAY CHEMICAL APPLICATION SYSTEM FOR MACHINE WAREWASHING APPLICATIONS

(71) Applicant: ECOLAB USA INC., Saint Paul, MN (US)

(72) Inventors: Michael Ney, Minneapolis, MN (US); Matthew Peltier, Cottage Grove, MN (US); John Mansergh, Cottage Grove, MN (US); Andrew M. Jensen, Saint Paul, MN (US)

(21) Appl. No.: 19/436,664

(22) Filed: Dec. 30, 2025

Related U.S. Application Data
(60) Provisional application No. 63/740,582, filed on Dec. 31, 2024.

(51) Int. Cl. A47L 15/42; A47L 15/00; C02F 1/00; C02F 1/42

(52) U.S. Cl. CPC A47L 15/4282; A47L 15/0081; A47L 15/4202; A47L 15/4225; A47L 15/4229; A47L 15/4293; A47L 15/4295; C02F 1/001; C02F 1/42; A47L 2401/04; A47L 2401/26; A47L 2501/06; A47L 2501/20; A47L 2501/28; A47L 2501/30; C02F 2307/12

(57) ABSTRACT

Methods of cleaning an article in a dishmachine are disclosed employing a direct application of cleaning or rinsing composition to an article in a dishmachine for enhanced cleaning performance. The methods beneficially provide a reduction in cycle time, water consumption and/or total concentration of the composition compared to conventional dishmachine usage applying the cleaning or rinsing composition from the sump of the dishmachine.

### CROSS REFERENCE TO RELATED APPLICATIONS

This application claims priority under 35 U.S.C. § 119(e) to provisional patent application U.S. Ser. No. 63/740,582, filed Dec. 31, 2024. The provisional patent application is hereby incorporated by reference in its entirety herein, including without limitation: the specification, claims, and abstract, as well as any figures, tables, appendices, or drawings thereof.

### TECHNICAL FIELD

The disclosure relates generally to method of cleaning an article in a dishmachine employing a direct application of cleaning or rinsing composition to an article in a dishmachine for enhanced cleaning performance with a reduction in total concentration of the composition compared to conventional dishmachine usage applying the cleaning or rinsing composition from the sump of the dishmachine.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

There remains an interest in continual improvement for water and energy savings in the warewash space, including both customer and institutional dishwashing. Methods and cleaning compositions for optimized soil removal remain a priority for customers and institutions. These priorities for continued improvement in the methods of dishwashing can benefit from reductions in water, chemistry and energy usage and consumption. Moreover, labor savings that result from these improvements are further desired while maintaining or enhancing cleaning performance.

Known dishwashing methods have historically utilized water softeners in an effort to increase the efficacy of cleaning chemistries for wares. The effectiveness of such water softeners with about 3-5 grain water is limited.

Prior dishmachines place chemistry into the sump. This chemistry interacts with whatever is in sump, and this generally hard water or soil loads. Dispensing chemistries into the sump is a problem because it is less effective than applying the chemistry directly. A typical approach was to combine the chemistry with pristine water. The chemistry must hit the ware first and then go into the sump.

Thus, there exists a need in the art for an apparatus which provides methods of dishwashing employing direct chemistry, including cleaning or rinsing compositions, applications that have better efficacy in cleaning wares than those known in the art.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide methods of dishwashing that provide efficacious and complete removal of soils with various cleaning compositions, including cost conscious detergent compositions, through use of improved methods of cleaning to enhance performance beyond the same removal with traditional application methods.

It is still yet a further object, feature, and/or advantage of the present disclosure to provide methods of dishwashing employing direct chemistry applications that reduce both cleaning cycle time and water consumption.

It is still yet a further object, feature, and/or advantage of the present disclosure to provide nearly 360-degree coverage.

It is still yet a further object, feature, and/or advantage of the present disclosure to provide a direct application solution which is agnostic as to temperatures within the wash machine.

It is still yet a further object, feature, and/or advantage of the present disclosure to remove nearly all soils on wares regardless of where the ware is placed within the chamber of the dishmachine, and even in the event one ware shields another ware from view of one or more of the nozzles that sprays the cleaning chemistries (i.e. it is an aim to mitigate issues associated with shielding).

It is still yet a further object, feature, and/or advantage of the present disclosure to reduce cycle time, and preferably to reduce the cycle time from 60 to 90 seconds to between 30 and 60 seconds, and most preferably to a time of even less than 30 seconds.

It is still yet a further object, feature, and/or advantage of the present disclosure to reduce the need for re-washing and to provide more streamlined options for washing wares.

It is still yet a further object, feature, and/or advantage of the present disclosure to provide more efficacy with respect to removing soils from wares using an equivalent amount or a lesser amount of chemicals in the cleaning chemistries that are being applied to the wares.

It is still yet a further object, feature, and/or advantage of the present disclosure to allow for the use of off-the-shelf nozzles so that the operator can select different sizes for different flow rates, and/or to facilitate easy replacement of damaged nozzles. The size of droplets hitting ware can be critical; droplets that get too big can have much worse coverage. Too high of pressures can result in mists where the droplets are too small and there become issues in being able to remove soils despite adequate coverage. The nozzles can have many different spray types, and different nozzles can be aligned with different chemistries: e.g., 1 on top and 1 on bottom; staggered; two nozzles adjacent to one another that work in tandem, etc.

It is still yet a further object, feature, and/or advantage of the present disclosure to allow chemical reactions to occur on the ware.

It is still yet a further object, feature, and/or advantage of the present disclosure to program an intelligent control to determine how long to run the wash cycle based upon a type or an amount of soil located on the wares, to determine where to directly apply chemistries within the chamber by automatically adjusting an angle of at least one of the plurality of direct application nozzles, to adjust a temperature of the wash water or rinse water based upon a type or an amount of soil located on the wares, and to determine how long to run the wash cycle, where to directly apply chemistries within the chamber, and/or to adjust a temperature of the wash water or the rinse water based upon a type of the ware.

The direct application methods of applying concentrated chemistries disclosed herein can be used in a wide variety of applications. For example, aside from dishmachines, similar solutions could also be offered in washing machines for clothes, in power washers for cleaning equipment outdoors, and so on and so forth. Aside from dishmachines, pre-scrap machines, which require no preparation, can allow for all soils to go into the machine that utilizes the direct application chemistries. The dishmachine can also be agnostic regarding whether it is a recirculating type machine that recirculates water for re-use, or it can also be a machine specifically designed to be free from the recirculation of rinse and wash water.

It is preferred the apparatus be safe, cost effective, and durable. For example, it is preferable to reduce potential damage (breaking, warping, etc.) to wares during the wash cycle. Additionally, it is to be appreciated that the dishmachine is designed to operate while being level. This can help to prevent any damage to the machine during operation and to ensure the best results when washing ware(s). The unit can therefore come with adjustable bullet feet, which can be turned using a pair of channel locks or by hand if the unit can be raised safely.

Methods can be practiced which facilitate use, manufacture, assembly, maintenance, and repair of a dishmachine which accomplish some or all of the previously stated objectives. A wholistic approach can be provided so that features of the present disclosure can be provided with an OEM dishmachine.

The dishmachine can be incorporated into systems or kits which accomplish some or all of the previously stated objectives. For example, nozzle systems can be incorporated into kits which can then be retrofit to existing ware-washing machines so as to provide for the ability to provide direct application solutions.

According to some aspects of the present disclosure, methods of cleaning an article in a dishmachine comprise: rinsing the article in the dishmachine with water from a sump; applying a cleaning or rinsing composition directly to the article in the dishmachine with a contact time of about 1 second to about 15 seconds, wherein the direct application does not dilute the cleaning or rinsing composition in the sump of the dishmachine before contacting the article; and washing the article in the dishmachine with water from the sump; wherein the cleaning or rinsing composition is dosed at a total concentration less than a cleaning or rinsing composition applied as diluted chemistry from the sump of the dishmachine with improved cleaning or rinsing efficacy to methods employing the greater concentration of the diluted composition.

According to some other aspects of the present disclosure, the system for direct application of concentrated warewash chemistries to dishware in a commercial dishmachine can be applied by via a fine mist produced by delivery pumps and atomizing or fogging nozzles. To create the fine mist, the system is further designed to pump multiple concentrated warewash chemistries through said fogging nozzles that can coat ware with the wash chamber of a commercial dishwasher. Concentrated warewash chemistries are thus directly applied onto ware within commercial dishwasher and circumvent diluting the chemistry in the machine's wash tank or incoming water line.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 illustrates the components of the automated cleaning apparatus, such as a dishwash machine, according to an embodiment of the present invention.

FIG. 2 illustrates a direct spray chemical application system schematic and other advanced features for improved machine warewashing applications.

FIG. 3 shows a perspective view of an improved direct spray chemical application system for machine ware washing applications, according to some aspects of the present disclosure.

FIG. 4 shows a partially hidden view of the direct spray chemical application system of FIG. 3 emphasizing view of components within the chamber and some of the nozzle subsystem(s), according to some aspects of the present disclosure.

FIG. 5 shows a partially hidden view of the direct spray chemical application system of FIG. 3 emphasizing view of the components within the booster tank and some of the structural subsystem(s), according to some aspects of the present disclosure.

FIG. 6 shows a partially hidden view of the direct spray chemical application system of FIG. 3 emphasizing view of some of the components within the tub and some of the electronic subsystem(s), according to some aspects of the present disclosure.

FIG. 7 shows a partially hidden view of the direct spray chemical application system of FIG. 3 emphasizing view of some of the other components within the tub and some of the electronic subsystem(s), according to some aspects of the present disclosure.

FIGS. 8A-8C show component views of the direct spray nozzles that are located within the chamber of the direct spray chemical application system of FIG. 3, according to some aspects of the present disclosure.

FIG. 8A shows a perspective view of a push-to-connect tube fitting for air and water, according to some aspects of the present disclosure.

FIG. 8B shows a perspective view of an adapter, according to some aspects of the present disclosure.

FIG. 8C shows a perspective view of a misting nozzle, according to some aspects of the present disclosure.

FIG. 9 shows a perspective view of the plumbing subsystem within the chamber of the direct spray chemical application system of FIG. 3, according to some aspects of the present disclosure.

FIG. 10 shows an exploded view of a (lower) dispensing subsystem within the chamber of the direct spray chemical application system of FIG. 3, according to some aspects of the present disclosure.

FIG. 11 shows a detailed component view of the primary tube manifold of the direct spray chemical application system of FIG. 3, according to some aspects of the present disclosure.

FIG. 12 shows a detailed component view of the secondary tube manifold of the direct spray chemical application system of FIG. 3, according to some aspects of the present disclosure.

FIG. 13 shows a detailed component view of the lift arm of the direct spray chemical application system of FIG. 3, according to some aspects of the present disclosure.

FIG. 14 shows a detailed component view of the upper wash coupler of the direct spray chemical application system of FIG. 3, according to some aspects of the present disclosure.

FIG. 15 shows a detailed component view of the lower wash coupler of the direct spray chemical application system of FIG. 3, according to some aspects of the present disclosure.

FIG. 16 shows a detailed component view of the bulkhead to half hose barb fitting of the direct spray chemical application system of FIG. 3, according to some aspects of the present disclosure.

FIG. 17 shows a perspective view of a structural subsystem that defines and supports the chamber of the direct spray chemical application system of FIG. 3, according to some aspects of the present disclosure.

FIG. 18 shows a detailed component view of the rack guide of the direct spray chemical application system of FIG. 3, according to some aspects of the present disclosure.

FIG. 19 shows a detailed component view of the main chamber member of the direct spray chemical application system of FIG. 3, according to some aspects of the present disclosure.

FIG. 20 shows a detailed component view of the tank and strap enclosure of FIG. 3, according to some aspects of the present disclosure.

FIG. 21 shows a detailed component view of the strainer of the direct spray chemical application system of FIG. 3, according to some aspects of the present disclosure.

FIG. 22 shows a detailed component view of the control box of the direct spray chemical application system of FIG. 3, according to some aspects of the present disclosure.

FIG. 23 shows a detailed component view of the tank cover of the direct spray chemical application system of FIG. 3, according to some aspects of the present disclosure.

FIG. 24 shows a detailed component view of the display box of the direct spray chemical application system of FIG. 3, according to some aspects of the present disclosure.

FIG. 25 shows a detailed component view of the strainer of the direct spray chemical application system of FIG. 3, according to some aspects of the present disclosure.

FIG. 26 shows a detailed component view of the pump of the direct spray chemical application system of FIG. 3, according to some aspects of the present disclosure.

FIG. 27 shows a detailed component view of the valve subsystem of the direct spray chemical application system of FIG. 3, according to some aspects of the present disclosure.

FIG. 28 shows a detailed component view of the pump strainer of the direct spray chemical application system of FIG. 3, according to some aspects of the present disclosure.

FIG. 29 shows a detailed component view of the standpipe of the direct spray chemical application system of FIG. 3, according to some aspects of the present disclosure.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

### Warewashing Methods

Warewashing methods or methods of cleaning an article in a dishmachine are provided. The methods include applying a cleaning or rinsing composition directly to an article or articles in a dishmachine, wherein the direct application does not dilute the cleaning or rinsing composition in a sump of the dishmachine before contacting the article(s). The methods include washing the article(s) in the dishmachine with water from the sump of the dishmachine. It is unexpected that the direct application of the compositions results in improved performance even though the methods dose the cleaning or rinsing composition at a total concentration less than a cleaning or rinsing composition applied as diluted chemistry from the sump of the dishmachine. In some embodiments the direct application of the cleaning or rinsing composition provides a concentrated chemistry. In some embodiments the direct application of the cleaning or rinsing composition provides a concentrated chemistry having a concentration at least about 2 times to about 400 times greater percentage of active ingredients than a concentration of actives of the same cleaning or rinsing composition when applied as diluted chemistry from the sump of the dishmachine.

The direct application of the cleaning or rinsing compositions can include a contact time from about 1 second to about 15 seconds, from about 1 second to about 10 seconds, or from about 1 second to about 5 seconds, or any range therebetween. In embodiments, the direct application of the cleaning or rinsing compositions can include a contact time of at least about 1 second, at least about 5 seconds, or at least about 10 seconds, or any range therebetween.

The washing step with water from the sump following the direct application of the cleaning or rinsing compositions can include a cycle time from about 1 second to about 45 seconds, from about 1 second to about 30 seconds, or from about 1 second to about 15 seconds, or any range therebetween.

It is beneficial that the direct application of the cleaning or rinsing compositions provides such significant improvements in cleaning that the overall cycle time, the total cleaning cycle time, can be reduced. This reduction of cycle time for the dishmachine beneficially provides an increased throughout of the dishwashing machine. In a still further benefit the reduced cleaning cycle time also provides a beneficial reduction in the water consumption during the warewashing.

The methods can employ water of various conditions, including softened water or hard water without negatively impacting the efficacy of the cleaning of the articles. In embodiments the water has a hardness level from about 0 grains per gallon (gpg) to about 17 gpg.

The methods can employ water at various temperatures, including from about 95° F. (35° C.) to about 176° F. (80° C.). The temperature of washing steps can vary depending on the dishmachine, for example if the dishmachine is a consumer dishmachine or an institutional dishmachine. The temperature of the washing step, namely the temperature of the water from the sump in a consumer dish machine is typically about 110° F. (43° C.) to about 150° F. (66° C.) with a rinse up to about 160° F. (71° C.). The temperature of the washing step in a high temperature institutional dishmachine in the U.S. is about typically about 150° F. (66° C.) to about 165° F. (74° C.) with a rinse from about 180° F. (82° C.) to about 195° F. (91° C.). The temperature in a low temperature institutional dishmachine in the U.S. is typically about 120° F. (49° C.) to about 140° F. (60° C.). The temperature in a high temperature institutional dishmachine in non-US markets, such as Asia, is typically from about 131° F. (55° C.) to about 136° F. (58° C.) with a final rinse at 180° F. (82° C.).

An even further reduction in water consumption is achieved by the methods as the washing step of the article(s) in the dishmachine after the direct application of the composition is with water from the sump of the dishmachine. This sump water can be recycled for numerous cycles as the direct application of the compositions provides efficacious cleaning or rinsing that enables the washing cycle to use recycled water under various conditions, including water hardness levels and total dissolved solids (TDS).

In embodiments, wherein the water is reused in the dishmachine any number of washing cycles can reuse the sump water until an undesirable level of foaming within the dishmachine is met requiring the dumping and refilling of the sump, or until a threshold change in cleaning efficacy is met requiring the dumping and refilling of the sump, and/or until a maximum threshold for TDS within the dishmachine exceeds a level requiring the sump to be dumped and refilled. In some embodiments, a TDS threshold of at least about 30,000 TDS, at least about 50,000 TDS, or greater is met before dumping and refilling the sump. The ability to use and reuse sump water for the warewashing cycles beneficially reduces water consumption through reuse of the water in the dishmachine.

The methods described can employ either use solutions of the cleaning or rinsing compositions, or alternatively can employ concentrate compositions. The methods described provide improved cleaning and rinsing efficacy compared to methods employing the greater concentration of the diluted composition from the sump of the dishmachine.

In an embodiment where the cleaning or rinsing composition applied directly to the article(s) is a concentrated chemistry, beneficially a diluted concentrated can be applied directly to the articles due to the lower concentration required according to the methods described herein, compared to dosing of the concentrated cleaning or rinsing composition into the sump of the dishmachine. In embodiments a concentrated cleaning or rinsing composition can be diluted by about a factor of 5, 10, 15, or greater. For example, a 20% or greater concentrate can be diluted to about 0.5% for the direct application of the cleaning or rinsing composition.

The manner by which the direct applying of the cleaning or rinsing composition is achieved with the dishmachine is a non-limiting embodiment of the methods. Various contacting methods are known for applying a liquid composition within a dishmachine, such as spraying, foaming, misting, or a combination thereof. In an embodiment, the direct applying of the composition is by an upper and/or lower spray arm within the dishmachine. In another embodiment, the direct applying of the composition is by one or a plurality of misting nozzles within the dishmachine. The spraying or misting of the composition substantially covers the article(s) with the cleaning or rinsing composition.

Various amounts of the compositions can be applied to the article(s) based on factors including the type and concentration of the cleaning or rinsing composition, the nature and degree of the soils on the article(s), the temperature of the water for the washing cycle, the type of water in the washing cycle, and the like as will be apparent to a skilled artisan based on the disclosure herein.

In some embodiments, the spraying or misting applies from about 1 gram to about 75 grams of the cleaning or rinsing composition. In some embodiments, the spraying or misting applies from about 1 gram to about 50 grams of the cleaning or rinsing composition. In some embodiments, the spraying or misting applies from about 25 ppm to about 2,000 ppm cleaning or rinsing composition, or from about 50 ppm to about 1,000 ppm cleaning or rinsing composition, including all ranges therebetween.

In embodiments where the cleaning composition is a caustic composition, the spraying or misting applies at least about 25 ppm active caustic, or at least about 50 ppm active caustic to the article. In further embodiments wherein the cleaning composition is a caustic composition, the spraying or misting applies from about 25 ppm to about 500 ppm active caustic, or from about 50 ppm to about 250 ppm active caustic to the article.

The methods described can employ a variety of cleaning compositions, rinsing compositions, or a combination of cleaning and rinsing compositions. In embodiments the composition is a detergent, a rinse aid, or a combination thereof. The compositions preferably have an alkaline pH and can contain a variety of actives for cleaning and/or rinsing wares. pH ranges for the alkaline pH can vary depending upon the types of soils to be removed and cleaned.

Exemplary alkaline compositions can include one or more alkalinity sources and/or alkaline carriers. Some non-limiting suitable examples include the following: a hydroxide such as sodium hydroxide or potassium hydroxide; an alkali silicate; an ethanolamine such as triethanolamine, diethanolamine, and monoethanolamine; an alkali carbonate; and mixtures thereof. The alkalinity is preferably a hydroxide or a mixture of hydroxides. The alkaline composition preferably creates a diluted solution having a pH from about 7 to about 14, more preferably from about 9 to about 13, and most preferably from about 10 to about 12.

The alkaline compositions may optionally include additional ingredients. For example, the alkaline composition may include a surfactants, polymers, water conditioning agents, chelants, enzymes (such as for example the proteases, amylases, cellulases, and lipases), enzyme stabilizing systems, binding agents, antimicrobial agents, bleaching agents, defoaming agent/foam inhibitors, antiredeposition agents, catalysts, chlorine scavenger anions, dye or odorant, carriers, hydrotropes, coupling agents, or solubilizers that aid in compositional stability, and aqueous formulation, and mixtures thereof any of the aforementioned in formulating the cleaning or rinsing compositions for use herein.

The methods can further include an initial manual or automatic step for removing bulk or scrap soils from the article(s). In an embodiment the methods further comprise a first step of bulk removal or prescrapping of soils from the articles before they are placed in the dishmachine. In still other embodiments, the methods further comprise a first step of bulk removal or prescrapping of soils from the articles that takes place within the dishmachine.

The methods can further include an initial preflush or rinse step of the article(s) in the dishmachine before applying the cleaning or rinsing composition. As referred to herein, a preflush is used to remove significant amounts of soils, such as greater than about 5 g of soils and/or larger solid masses (e.g. noodles, meatballs, etc.). As referred to herein, a rinse step is what is used for removing soils, such as greater than about 5 g of soils, that are predominantly or all liquid mass (e.g. sauces, ketchup, soup, etc.).

The methods can further include a final rinsing step, without or without the use of a rinsing composition and/or rinse aid.

The methods are not limited to the type of dishmachine for performing the methods. A variety of dish machines can be employed, including consumer or institutional dish machines, including for example those described in U.S. Pat. No. 8,092,613, which is incorporated herein by reference in its entirety, including all figures and drawings. The dish machines may be either single tank or multi-tank machines. In a preferred embodiment the dishmachine is an institutional dish machine. Exemplary dishmachines include for example, a door dish machine, a hood dish machine, a conveyor dish machine, an undercounter dish machine, a glasswasher, a flight dish machine, a pot and pan dish machine and a utensil washer.

A door dish machine, also called a hood dish machine, refers to a commercial dishmachine wherein the soiled dishes are placed on a rack and the rack is then moved into the dishmachine. Door dishmachines clean one or two racks at a time. In such machines, the rack is stationary and the wash and rinse arms move. A door machine includes two sets arms, a set of wash arms and a rinse arm, or a set of rinse arms.

Door machines may be a high temperature or low temperature machine. In a high temperature machine the dishes are sanitized by hot water. In a low temperature machine the dishes are sanitized by the chemical sanitizer. The door machine may either be a recirculation machine or a dump and fill machine. In a recirculation machine, the cleaning solution is reused, or “recirculated” between wash cycles. In a dump and fill machine, the wash solution is not reused between wash cycles. New detergent solution is added before the next wash cycle. As described herein, the methods of the invention benefit from the use of a recirculation machine over a dump and fill machine. Some non-limiting examples of door machines include the Ecolab Omega HT, the Hobart AM-14, the Ecolab ES-2000, the Hobart LT-1, the CMA EVA-200, American Dish Service L-3DW and HT-25, the Autochlor A5, the Champion D-1-1B, and the Jackson Tempstar.

### Warewashing Systems & Dishmachines

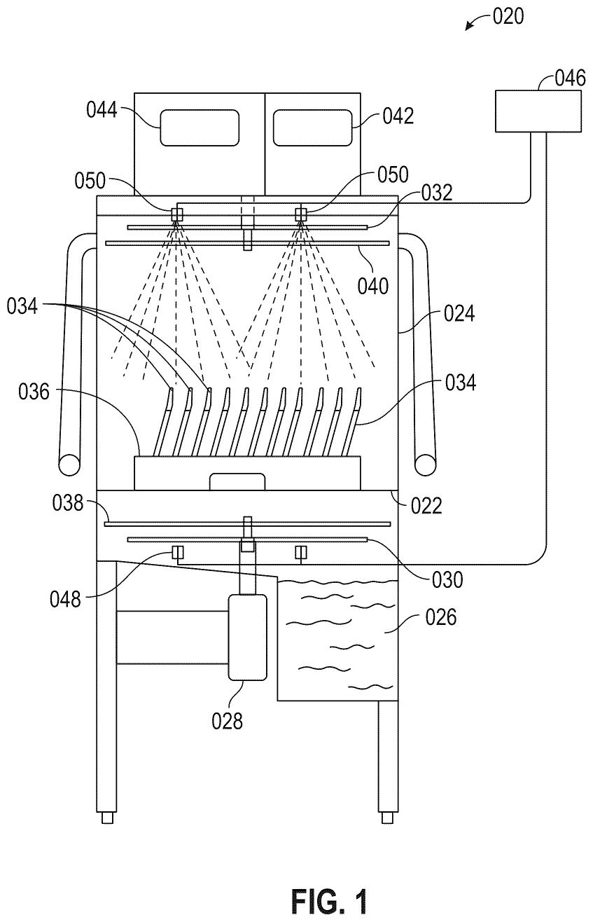

Referring to FIG. 1, the components of an automated cleaning apparatus 020 are illustrated according to one exemplary embodiment of the present invention. The cleaning apparatus 020 includes a shelf 022 which the articles to be washed are placed. The cleaning apparatus 020 may be a commercial recirculated wash type dish machine with a standard dish rack, although other cleaning apparatuses may be employed, including without limitation cleaning apparatuses for cleaning articles where direct application of the cleaning or concentrated product to the article provides benefits over existing systems.

The cleaning apparatus 020 includes a cabinet body 024 housing the shelf 022. A wash tank or sump 026 is included for holding generally a large amount of bulk wash liquids used in the cleaning process. A pump is connected in fluid communication with the wash tank or sump 026 for increasing the pressure of the liquid in the wash tank or sump 026 and directing it to wash spray arms 030 and 032. The wash spray arms 030 and 032 include nozzles for directing the liquid onto the articles 034 in the rack 036. In addition to the lower and upper wash spray arm 030 and 032, the cleaning apparatus 020 may include a lower rinse spray arm 038 and an upper rinse spray arm 040 for directing rinsing liquids onto articles 034 in the rack 036. The spray pressure may be controlled by controlling the pump action or by use of a manifold valve (not shown). For example, when washing a lighter, plastic article, a lower spray pressure from the lower wash or rinse arm may be desirable so as not to disorientate the article within the cleaning apparatus 020.

An identifier (not shown) is positioned on the rack 036. This will allow identification of the types of articles 034 loaded onto the rack 036. The identifier is preferably pre-programmed with unique identifying information, such as an identifier value indicating the type of rack 036 being used, i.e., a rack designated for cups, plates, flatware, glasses, pots and pans, etc. Identification of the articles could also be done, for example, by use of specifically designed ware racks 036; by use of optical recognition; by use of bar codes; by color of the rack 036; by affixing a transponder to the articles 034 themselves; or by use of a proximity sensor. Examples of various types of articles 034 include without limitation, glassware, pots and pans, plates, cups, flatware, coffee cups, aluminum sheet pans, and any other article type associated with a common cleaning sequence, such as those that could be cleaned using apparatus 020 of the present invention.

The cleaning apparatus 020 could also include a user interface, such as a graphical user interface (“GUI”), for an operator or user to manually input the type of articles 034 loaded onto the rack 036. Using the automated article identifying method and system described above and incorporated by reference herein, the control device upon detection of the identifier associated with the rack 036 indicating the type of articles 034 to be cleaned, may be displayed at the user interface 042 for indicating to the operator or user the type of articles or wares that the cleaning apparatus 020 has identified in the rack 036.

The cleaning apparatus 020 also includes a chemical dispenser 046 adapted to receive chemical dispensing instructions from the controller 044. The dispenser 046 may include any number of cleaning or concentrated products, such as cleaning chemicals for dispensing to the cleaning apparatus 020. The dispenser 046 includes one or more dispenser pumps. For example, depending upon the number of chemicals being dispensed, the number of dispenser pumps may be altered accordingly. In an exemplary embodiment of the present invention, the dispenser 046 includes three or more, or six or less dispenser pumps. Additional dispenser pumps are possible. The term pump could be an aspirator or other means for delivering a chemical to be sprayed onto the soiled surface of the articles loaded in the rack 036. The dispenser 046 can be connected in fluid communication with spray points within the body of the cleaning apparatus 020. In one aspect of the present invention, the cleaning apparatus 020 includes one or more lower spray points 048 and/or one or more upper spray points 050. The upper and lower spray points 048 and 050 include nozzles with an opening directed at the rack 036 and articles 034 in the rack 036. Depending upon the article and/or the soil type on the article, the controller 044 provides a dispensing instruction to the dispenser 046 for spraying product, such as chemicals, from either the top or bottom or both spray points within the cleaning apparatus 020. The spray points are generally determined based on the type of ware and/or the soil type on the ware being cleaned. For cups, product is sprayed directly onto the cups loaded in the rack 036 from the lower spray points 048 to apply product onto the soiled inner surface of the cups. For example, to effectively remove tea and coffee stains from coffee cups, the concentrated product is dispensed from the lower spray points since cups are traditionally loaded face down in the rack 036. Similarly, for plates, the product is sprayed from the upper spray points 050 so as to be applied directly to the surface of the plate needing to be cleaned. Since plates generally face upward when loaded in the rack 036, applying product from the upper spray points 050 provides the most efficient and effective use of product being dispensed directly onto the plates. Conversely, applying concentrated product from the lower spray points 048 to the backside of the plates is wasteful. Product could be dispensed from both the lower spray point 048 and the upper spray points 050 simultaneously if needed for articles that are soiled on both the top and bottom surfaces. In another aspect of the present invention, concentrated chemical is applied to the articles 034 using the lower rinse spray arm 038 and/or the upper rinse spray arm 040 based upon the concentrated product dispense cycle, the wash cycle or the rinse cycle. In this embodiment, the dispenser 046 is connected in fluid communication with the lower rinse spray arm 038 and the upper rinse spray arm 040 for directing concentrated product from the dispenser onto the onto articles 034 in the rack 036. Thus, the cleaning apparatus 020 may be configured without the upper and lower spray points 048 and 050 shown in FIG. 1 when the dispenser applies concentrated product onto the articles 034 using the lower rinse spray arm 038 and the upper rinse spray arm 040. In this manner, cleaning products such as chemicals are only applied generally to the soiled surface of the article being cleaned rather than all the surfaces of the article. Although the cleaning apparatus 020 illustrates both lower and upper spray points 048 and 050, the present invention contemplates that additional spray points may be included depending on the ware type being cleaned. For example, spray points may be included at side or corner locations within the cabinet body of the cleaning apparatus 020 to provide the best angle for spraying and applying cleaning or concentrated product directly onto the soiled surface of the articles 034.

The controller 044 of the present invention is programmed to spray concentrated product, wash liquid and rinse liquid from the upper and/or lower spray points 048 and 050 based upon at least one or more of the following factors, including the product dispensing sequence, the article type, soil type, ware type, water condition, the concentrated product type, the wash cycle, the rinse cycle, the detergent concentration of the recirculated wash, etc.

The present invention contemplates that the cleaning apparatus 020 may include any number of product dispensing sequences stored on a data storage device (not shown) in operable control and communication with controller 044. The data storage device (not shown) may be used to store an array of pre-determined chemical combinations and cycle sequences and durations specifying cleaning chemicals to be used according to the various types of articles and/or soil type.

This method of introducing warewash chemistries directly into the wash tank of a dish machine and then recirculating across the ware can be affected by varying water conditions, temperatures, and food soil loads.

By directly apply the chemistry to the ware surface via a fine spray we can circumvent these factors while also achieving increased wash performance due to the concentrated nature of the chemistry. Additionally, an improved direct spray system 060 focuses around auto-prescrapping, as is now more common for commercial dishwashers to run even higher food soil loads. The improved direct spray system 060 repurposes the machines 020 onboard delime pump to pump alternate chemistry through a pipe manifold and nozzles. Following that concept, the design moved to new pumps, routed tubing, and fogging nozzles to provide a fine mist of chemical spray.

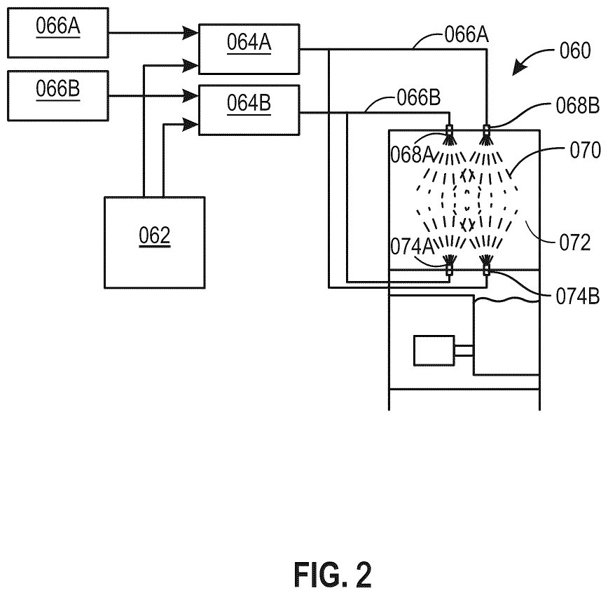

The improved direct spray system 060 of FIG. 2 improves the machine 020 with the addition and/or substitution of the components 062-072 with respect to the components 022-050. As such, reference characters for components 022-050 are omitted within FIG. 2 so that discussion is focused on the components 062-072.

FIG. 2 outlines the general schematic for the improved direct spray system 060. A control board 062 controls operation of two distinct pumps 064A, 064B each able to deliver small volumes of respective chemistries 066A, 066B to hydraulic atomizing nozzles 068A, 068B. These nozzles 068A, 068B shear the chemistries 066A, 066B into a fine mist 070 that coats entire surfaces within the wash chamber 072.

The control board 062 can control both the order and duration of the spray within the wash sequence, which can be setup for specific ware types and soils.

FIG. 2 shows a design of the pumping system 064 to deliver chemistries 066A, 066B. In this pumping system 064, the pumps 064A, 064B are able to provide sufficient pressure to effectively shear the chemistries 066A, 066B through the atomizing nozzles 068A, 068B and mist the wash chamber. The pumps 064A, 064B are set up to deliver chemistry 066A, 066B to various nozzle locations independently (e.g. the chemistry A nozzle 068A, and the Chemistry B nozzle 068B, and upper and lower spray points 048, 050).

FIG. 2 shows the nozzle system 068, which includes the internal mounting of the nozzles 068A, 068B within the wash chamber 072. Multiple nozzles 068A, 068B are able to spray multiple chemistries 066A, 066B independently to provide full coverage of the wash chamber area. Additional sets of nozzles 074A, 074B are located on the lower side of the wash chamber 072 and oriented upwards to spray ware from underneath.

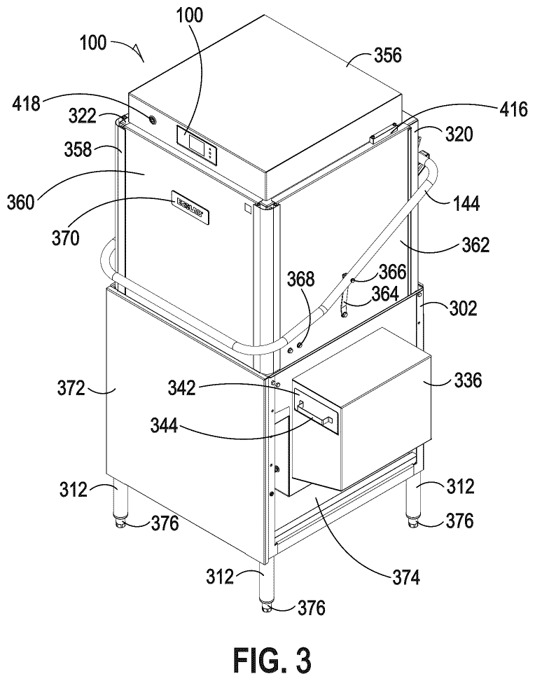

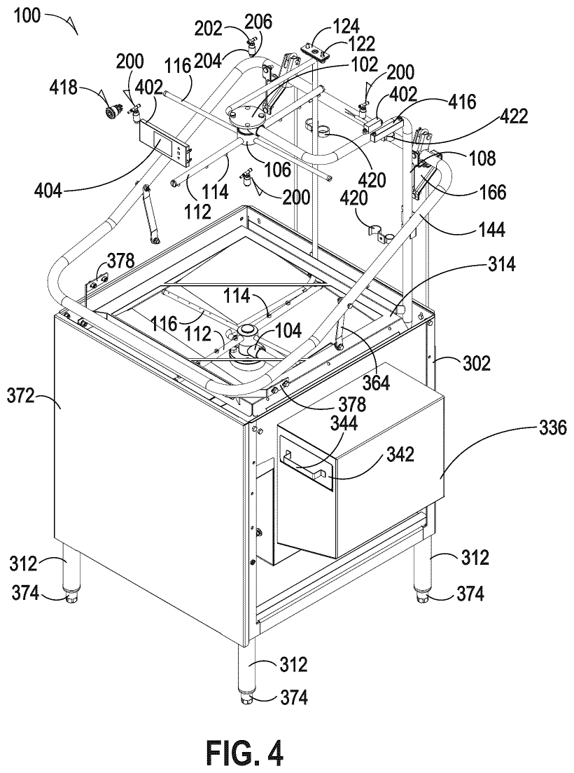

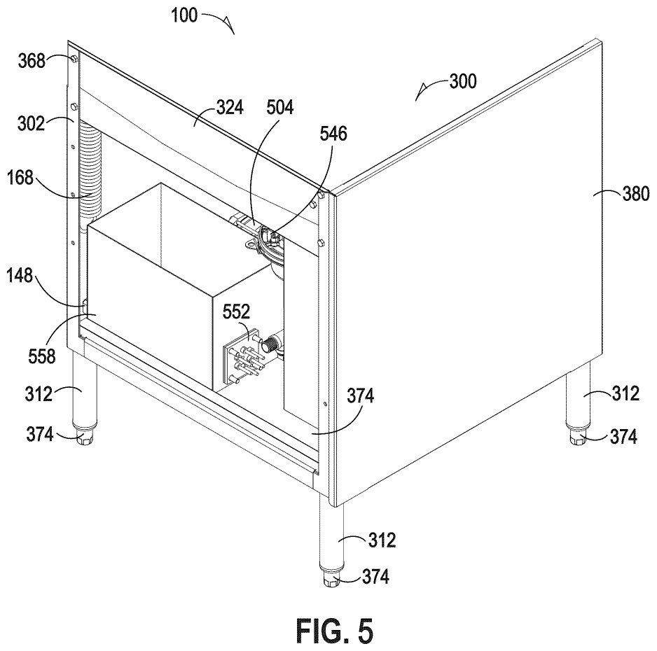

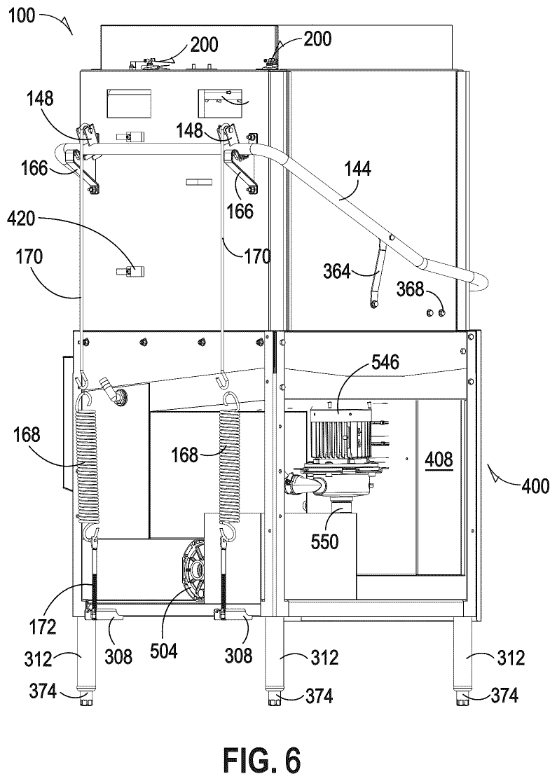

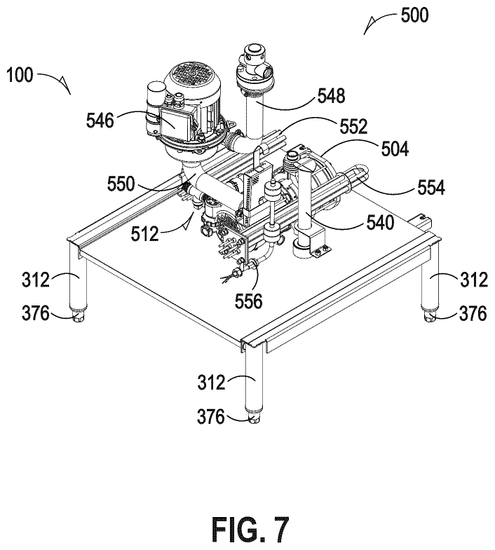

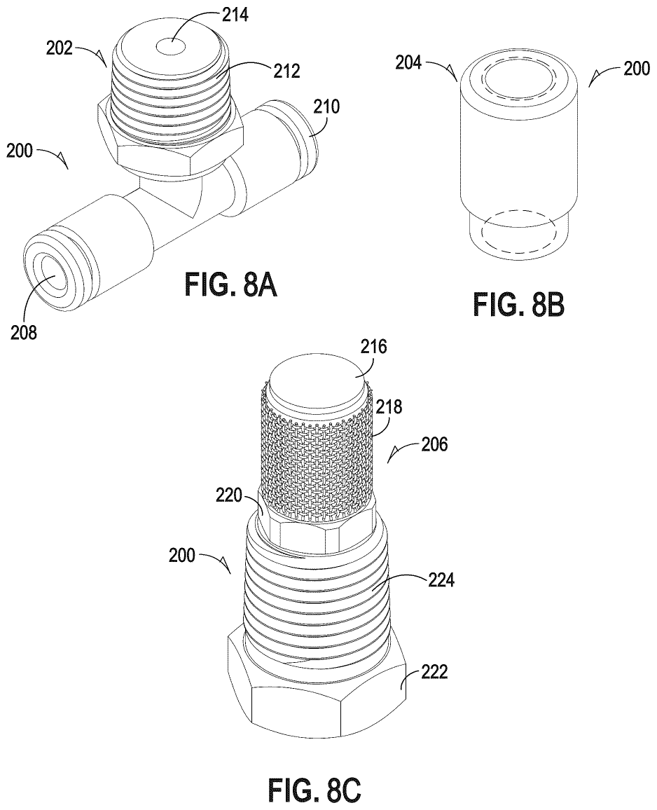

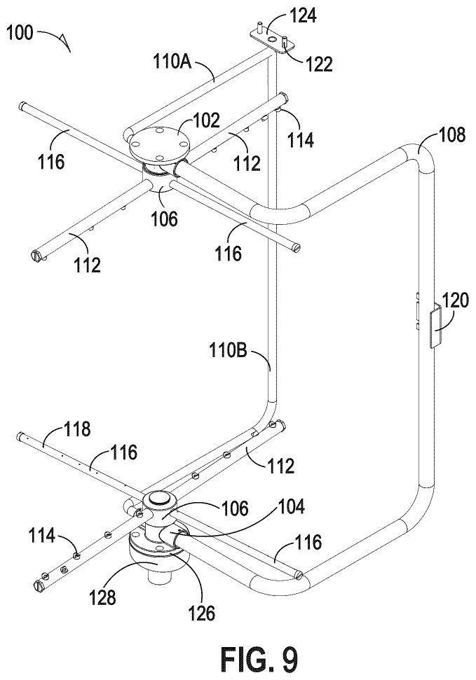

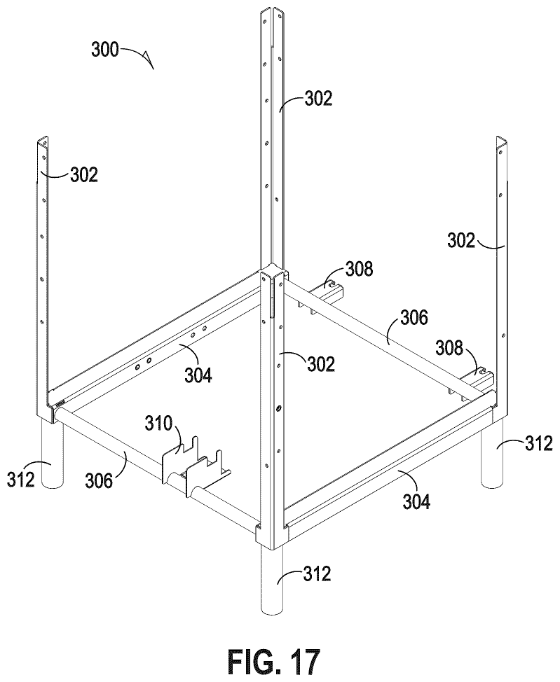

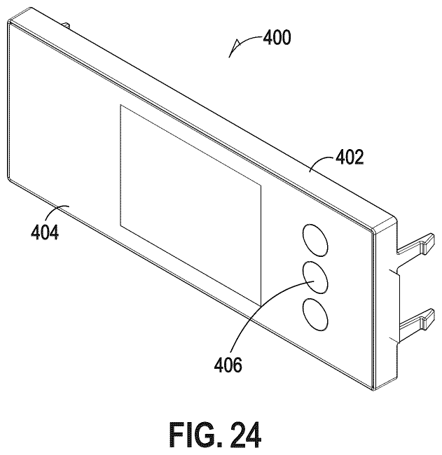

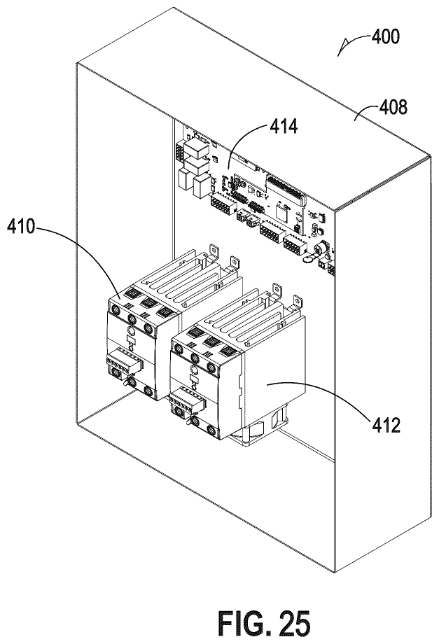

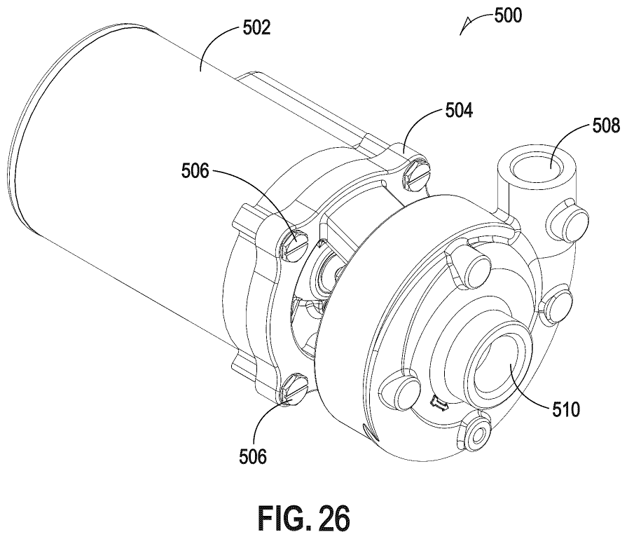

Referring now to FIGS. 3-29, a direct spray chemical application system 100 comprises several subsystems. The several subsystems can include, but are not limited to including: a plumbing subsystem (see e.g., FIG. 3) with example components, e.g. components 102-172, shown in detail throughout FIGS. 9-16; a direct application nozzle subsystem 200 (see e.g., FIG. 4) with example components, e.g. components 202-224, shown throughout FIGS. 8A-8C; a structural subsystem 300 (see e.g., FIG. 5) with example components, e.g. components 302-380, shown in detail throughout FIGS. 17-23; an electronics subsystem 400 (see e.g., FIG. 6) with example components, e.g. components 402-422, shown in detail throughout FIGS. 24-25; and a pumping subsystem 500 (see e.g., FIG. 7) with example components, e.g. components 502-558, shown in detail throughout FIGS. 26-29. For purposes of simplicity and to facilitate a more wholistic understanding of the present disclosure, the detailed description of these components shall be discussed together, and generally in ascending order according to their reference characters.

As shown in FIGS. 8A-8C, a significant benefit of the invention is to provide a plurality of direct application nozzles 200 that are fluidly connected to one or more chemical dispensers throughout the chamber. The plurality of direct application nozzles 200 are beneficially connected to distinct chemical dispensers that have different chemical solutions and thus allow for a more customized application of chemicals to certain types of wares. This allows for a more direct application of cleaning chemicals, as opposed to having to mix and rinse chemical solutions in a sump before applying the cleaning chemicals to wares.

A first plurality of plurality of direct application nozzles 200 (e.g., wash nozzles) are attached to an upper portion of the chamber and are fluidly connected to a first chemical dispenser 066A. A second plurality of plurality of direct application nozzles 200 (rinse nozzles) are attached to an upper portion of the chamber and are fluidly connected to a second chemical dispenser 068A. One or more additional direct application nozzle 200 (e.g., wash nozzle) is attached to a lower portion of the chamber and are fluidly connected to a first chemical dispenser 066A. Another one or more additional direct application nozzles 200 (e.g., rinse nozzle) is attached to a lower portion of the chamber and are fluidly connected to a second chemical dispenser 068A.

The location and number of direct application nozzles 200 can be critical to effective cleaning. For example, an alkaline detergent (no chelant or oxidizer) will not remove tea stain if the alkaline detergent is coming from the sump of the machine at typical use dilution (500-3000 ppm). However, when alkaline detergent comes directly in contact with the soil by being sprayed on the soil, the alkaline detergent will remove the stain. Even at dilute solutions, the alkaline detergent being sprayed on the soil can be effective. This can make it so that use of the direct spray chemical application system 100 is much more ambivalent regarding temperature of the rinse/wash waters, the chemical compositions and concentrations within the detergent, and the amount of water that is needed to clean wares. Instead, it is most important that the direct application nozzles 200 apply the detergent directly.

In a first example where one rack was washed at 17 gpg, HT—1 corner top nozzles, 4 nozzles on bottom, with 36 tiles up/and 36 tiles down, the upward facing tiles experienced far better cleaning than the downward facing tiles. This suggests that nozzle placement within the chamber and the spray patterns used largely effect cleaning.

In a second example where there was two spray nozzles on top and two spray on bottom, HT, 5 gpg in the sump, and approximately 56 grams sprayed per cycle, it only took 10 ppm of active caustic in the sump to completely remove tea stains from wares.

The direct application nozzles 200 are ideally misting-type nozzles. Each of the direct application nozzles 200 can thus comprise a push-to-connect tube fitting for air and water 202, an adapter 204, and a misting nozzle 206. The push-to-connect tube fitting for air and water 202 comprises threads 212. The air fitting 208 and the water fitting 210 are located upstream of an aperture 214 which delivers the chemistry 066A, 066B to the misting nozzle 206.

The push-to-connect tube fitting for air and water 202 comprises an air fitting 208 and a water fitting 210 in-line and fluidly opposed to one another. The air fitting 208 is attached to an air supply or other type of fluidic supply (e.g. a chemical dispenser), and the water fitting 210 is attached to a water supply or another type of fluidic supply (e.g. a chemical dispenser). The push-to-connect tube fitting for air and water 202 can further comprises threads 212.

The misting nozzle 206 can comprise a mesh 218 wrapped around a central shaft 216. The mesh 218 in the misting nozzle can create a misting effect by allowing water to pass through many small orifices. The mesh 218 can also act as a filter, preventing larger particles like debris or sediment from entering the tiny opening of the nozzle 200 and clogging it, ensuring a consistent and fine mist by only allowing water droplets to pass through. The fineness of the mesh determines how small the particles it can filter out; and a higher mesh count indicates a finer filter and mist. A clean mesh is crucial for proper misting functionality of the direct application of the chemical cleaning compositions and prevents the need for frequent nozzle cleaning. The misting nozzle 206 can further comprise a hex head 222 and threads 224 located between the mesh 218 and the hex head 222.

Each of the threads 212 of the push-to-connect tube fitting for air and water 202 and the threads 224 of the misting nozzle 206 can secure to each end of the adapter 204. For example, each end of the adapter 204 can comprise female threads, which receive corresponding male threads 212, 224 of the push-to-connect tube fitting for air and water 202 and the misting nozzle 206, respectively.

The direct spray chemical application system and plumbing subsystem 100 are responsible for the transfer of water, cleaning solutions, discarded soils, and other fluids to be moved through the dishmachine.

The direct spray chemical application system 100 and plumbing subsystem as shown in FIG. 9 comprises two hubs: an upper hub 102 and a lower hub 104. Both the upper hub 102 and the lower hub 104 serve as manifold devices that permit fluidic connections from water supply(s), chemical dispensing devices, and/or one another, as they ideally comprise one or more inlet(s) and outlet(s). Each of the upper hub 102 and the lower hub 104 are attached to rotors 106, which are allow to rotate with respect to each of the upper hub 102 and the lower hub 104. Each of the upper hub 102 and the lower hub 104 are further permitted to attach to the primary manifold tube 108 and one of the upper secondary manifold tube 110A or the lower secondary manifold tube 110B.

The rotors 106 are attached directly to the wash arms 112 and the rinse arms 116. In FIG. 9, for example, each rotor 106 comprises a connection to two wash arms 112 which are parallel to and opposite one another, and two rinse arms 116 which are parallel to and opposite one another. However, it is to be appreciated that more or less than two wash arms 112 and two rinse arms 116 could be directly attached to each of the rotors 106.

The one or more wash arms 112 each include a plurality of nozzles 114. The nozzles 114 can be used to focus wash water so as to provide additional pressure on wares, if needed. The nozzles 114 can also be oriented so as to provide better coverage for wash water throughout the chamber. The nozzles 114 can work in tandem with the nozzle assemblies 200 that are permanently fixed at upper and lower spray points in the chamber to provide even better coverage, and can, for example, be configured so as to spray in a cone configuration throughout the chamber. The one or more rinse arms 116 each include a plurality of apertures 118. The apertures 118 allow for rinse water to be sprayed therefrom. The nozzles 114 and apertures 118 associated with the one or more wash arms 112 and one or more rinse arms 116 attached to the upper hub 102 are oriented to spray water downward and into the chamber. The nozzles 114 and apertures 118 associated with the one or more wash arms 112 and one or more rinse arms 116 attached to the lower hub 104 are oriented to spray water upward and into the chamber.

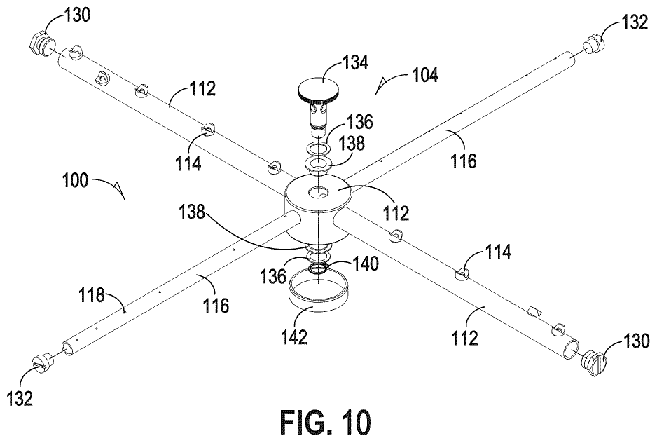

As shown in FIG. 10, the wash arms 112 can be plugged with removable wash arm plugs 130 at their distal ends and the rinse arms 116 can be plugged with removable rinse arm end caps 132 at their distal ends. The removable plugs 130 an removable end caps 132 are designed to protect the exposed ends of the wash arms 112 and rinse arms 116 by providing a cover that can be easily taken off and put back on, allowing for access to the internal part for cleaning, if necessary (e.g., in the event of a clog). Essentially, the removable plugs 130 an removable end caps 132 provide a barrier during operation that safeguard the internal parts of the wash arms 112 and rinse arms 116 from dust, moisture, debris, and other contaminants while in operation.

Also shown in FIG. 10, the lower hub 104 can specifically include a shaft arm 134. The shaft arm 134 in the lower hub 104 acts as a connecting piece, essentially a protruding section, that fits securely into a corresponding slot within the lower hub 104. This allows the shaft to transmit rotational power and torque from the rotor 106 to the wash arms 112 and rinse arms 116. The shaft arm 134 effectively arms the rotor 106 to be able to rotate in the hub 104. The shaft arm 134 can be a key part of a shaft-hub connection used in machinery to transfer motion and power. At a lower end of the lower hub 104, an O-ring 142 allows for connection to the lower hub gasket 126 and further helps seal the chamber near the drain. When the O-ring 142 is installed in a groove between two components, the O-ring is squeezed by the mating parts, creating a tighter seal. The material of the O-ring depends on the specific application, taking into account factors like temperature, pressure, and the type of fluid being sealed.

The shaft arm 134 attaches to the rotor 106 by way of a chemical-resistant plastic washer 136 and a seat 138. The O-ring 142 similarly attach to the rotor 106 by way of a chemical-resistant plastic washer 136 and a seat 138, as well as a retaining ring 140.

The retaining ring 140 acts as a secure mechanism to hold the rotatable components, such as bearings, in place on the axle, preventing them from sliding out while the rotor 106 rotates. The retaining ring 140 essentially helps keep all the parts of the lower hub 104 assembly together. The retaining ring 140 ensures smooth rotor 106 rotation and maintains proper alignment by keeping the bearings securely positioned

It is to be appreciated the upper hub 102 and the rotor 106 that is directly attached to the upper hub 102 can be configured in a similar such way, though with a reversed orientation.

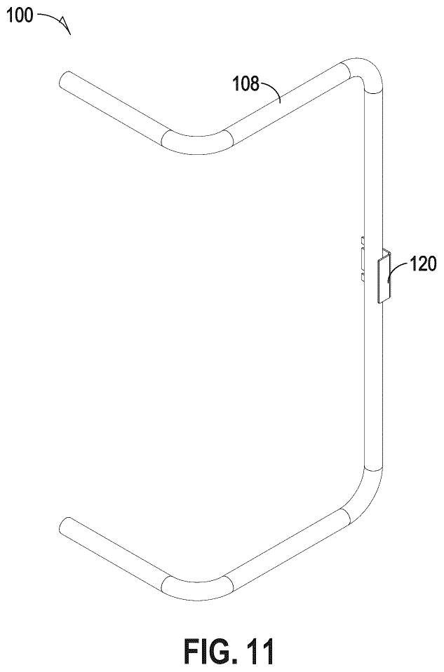

As shown in FIG. 11, a primary manifold tube bracket 120 secures the primary manifold tube 108 securely in place within the chamber. The primary manifold tube bracket 120 acts as a secure attachment point, holding the primary manifold tube 108 firmly in place against a wall of the chamber or other surface. The primary manifold tube bracket 120 further prevents the primary manifold tube 108 from moving freely, sagging, or vibrating, essentially providing support and stability to the piping system. The primary manifold tube bracket 120 is used to properly align and position the primary manifold tube 108 to transport fluids, such as wash fluid, from the upper hub 102 to the lower hub 104. By securely holding the primary manifold tube 108 in place, the primary manifold tube bracket 120 can help prevent potential leaks or damage from loose connections.

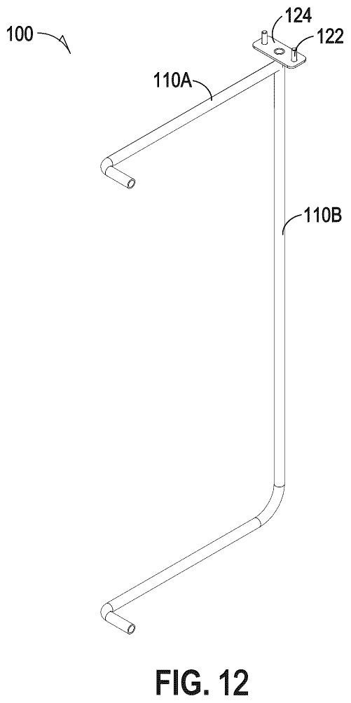

As shown in FIG. 12, the secondary manifold tube 110A, 110B comprises two halves. The secondary manifold tube 110A, 110B is smaller in diameter than the primary manifold tube 108. A secondary manifold tube mounting plate 122 secures the secondary manifold tube 110A, 110B securely in place within the chamber. The secondary manifold tube mounting plate 122 acts as a secure attachment point, holding the secondary manifold tube 110A, 110B firmly in place against a wall of the chamber or other surface. The secondary manifold tube mounting plate 122 further prevents the secondary manifold tube 110A, 110B from moving freely, sagging, or vibrating, essentially providing support and stability to the piping system. The secondary manifold tube mounting plate 122 is used to properly align and position the secondary manifold tube 110A, 110B to transport fluids, such as rinse fluid, from the upper hub 102 to the lower hub 104. Further included near the secondary manifold tube mounting plate 122 is a secondary manifold tube rinse gasket 124, which acts as a seal and prevents the rinse liquid from leaking out of the dispenser and onto the dishwasher door by creating a tight closure between the cap and the dispenser body. The main function of the watertight seal is to ensure proper rinse distribution during the wash cycle.

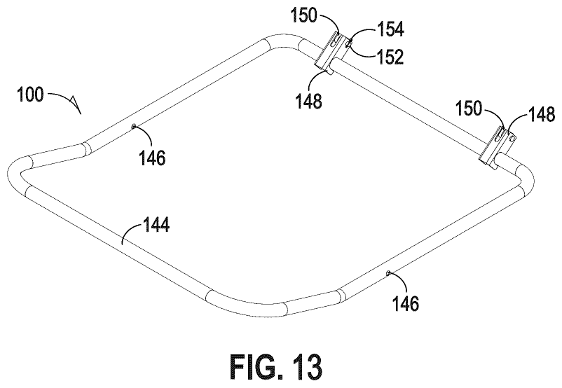

As shown in FIG. 13, the lift arm 144 comprises one member that completely surrounds the outside of the direct spray chemical application system 100 and can allow an operator to open and close a door of same, permitting access to and from the chamber. The lift arm 144 includes to apertures for fasteners 146 on an internal side of each side of the lift arm 144. At a back portion of the lift arm 144 are two mounting spring frames 148. The mounting spring frames 148 serve as a support system for the lift arm 144 by holding and distributing the tension of springs 168, allowing the lift arm 144 to provide flexibility and absorb shock when force is applied to the lift arm 144. This provides a more stable foundation for the lift arm 144. The mounting spring frames 148 secure and position springs 168 within the direct spray chemical application system 100, allowing them to compress and rebound effectively when force is applied.

The mounting spring frames 144 each include a bushing 150, a yoke 152, and a pin 154. The bushing 150 is a cylindrical sleeve that fits around a shaft to minimize friction and wear and acts as a cushion or bearing surface between the springs 168 and the lift arm 144. The bushing 150 reduces friction and wear by providing a smooth sliding surface and can help distribute shocks and stresses evenly. The bushing 150 can be made of bronze or plastic, depending on the application. The yoke 152 is a connecting piece that allows the springs 168 and the lift arm 144 to work together by distributing force evenly. The presence of two yokes 152 at each rear location of the lift arm 144, as it helps more effectively pull a load. The pin 154 is a solid, pointed piece that fastens the mounting spring frames 144 and yokes 152 in place.

Each of the mounting bracket spring frames 148 and the lift arm 144 are further supported bracket arms 166 (FIG. 6). A hook 170 attaches to the cantilever springs 168 at one end and at the hook's other end to the mounting bracket spring frames 148 near the bushing 150. A cantilever hang eye 172 attaches to a fixed portion of the base of the direct spray chemical application system 100 at its lower end and the bottom end of the cantilever springs 168 at its upper end. The cantilever spring 168 is a type of spring designed to provide a consistent, linear force over a wide deflection range by utilizing a semi-open metal strip. One end is fixed and the other end applies force, making it ideal for applications like energizing seals in reciprocating motions or situations with wide tolerance misalignments. The cantilever spring 168 creates a constant pressure against a surface by flexing its design.

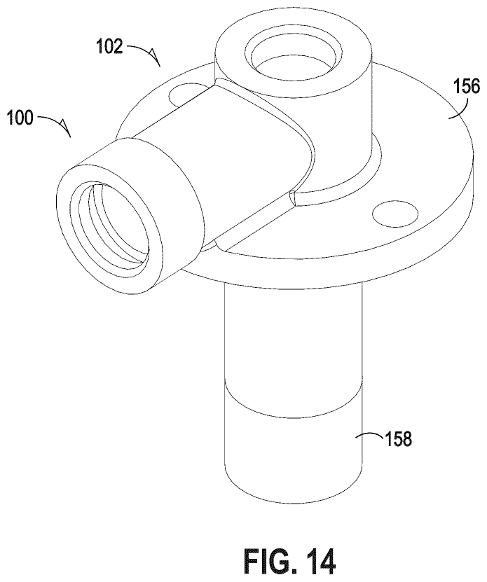

As shown in FIG. 14, the upper hub 102 can, for example, comprise three fluidic connections and can be located toward a roof of the chamber. A first fluidic connection is established between the upper hub 102 and the primary manifold tube 108, a second fluidic connection between the upper hub 102 and the upper secondary manifold tube 110A, and a third connection between the upper hub 102 a water source. The upper hub 102 can include an upper hub coupling portion 156 and an upper hub nipple 158, which is used to connect to other pipes or fittings. This allows the upper hub 102 to act as a connector to bridge a gap between longer sections of tubes where a direct connection isn't possible due to the difference in diameters in the tubes, differences in flow rate of the fluids traveling therebetween, and/or because the hub is necessary to act as a manifold to add a third fluidic connection.

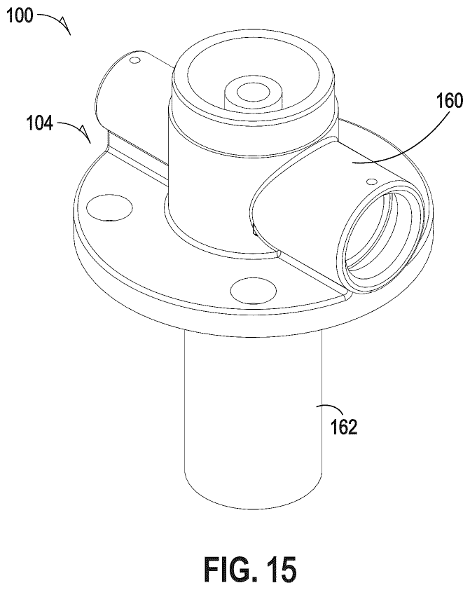

As shown in FIG. 15, the lower hub 104 can, for example, comprise three fluidic connections. A first fluidic connection is established between the lower hub 104 and the primary manifold tube 108, a second fluidic connection between the lower hub 104 and the lower secondary manifold tube 110B, and a third connection between the lower hub 104 a drain located at the bottom of the chamber. Between the lower hub 104 and the drain, a lower hub gasket 126 and a lower hub adapter 128 can help seal the bottom of the chamber to prevent liquids from passing through the chamber in areas other than the intended drain. The lower hub adapter 128 can also prevent wear toward the drain, as it is not directly attached to the rotor 106 like the lower hub 104 and therefore will not oscillate as much over time while the rotors 106 are repeatedly used. The lower hub 104 can include a lower hub coupling portion 160 and a lower hub nipple 162, which is used to connect to other pipes or fittings. This allows the lower hub 104 to act as a connector to bridge a gap between longer sections of tubes where a direct connection isn't possible due to the difference in diameters in the tubes, differences in flow rate of the fluids traveling therebetween, and/or because the hub is necessary to act as a manifold to add a third fluidic connection.

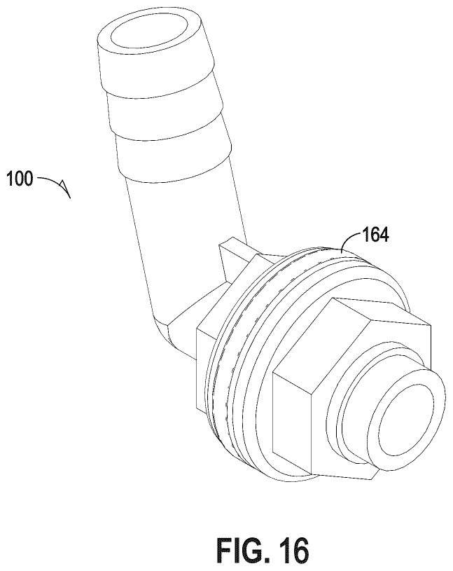

As shown in FIG. 16, a bulkhead to half hose barb fitting 164 securely connects a flexible hose to a the chamber wall by providing a leak-proof connection through the barrier. The bulkhead to half hose barb fitting 164 lets a hose run through a wall while maintaining the integrity of the chamber walls. The “half hose barb” part is the section with small ridges or barbs that grip the hose to create a tight seal. The “bulkhead” part is designed to pass through a wall or panel, creating a sealed connection on both sides.

A shown in FIG. 17, the structural subsystem 300 includes a lower half (also referred to as the “tub”) which comprises four leg frames 302, two side frames 304, and two cross frames 306. The leg frames 302 are vertically oriented and are connected perpendicularly to said side frames 304 and cross (front and rear) frames 306. The frames 302, 304, 306 provide the structural support for the entire appliance, holding all the key components like the tub, motor, spray arms, and racks in place, allowing the of the direct spray chemical application system 100 to function properly and maintain its shape during operation. The frames 302, 304, 306 function as the skeleton that keeps the structural subsystem 300 together. The frames 302, 304, 306 ensure the of the direct spray chemical application system 100 stays rigid and does not flex or warp under pressure from water and movement during the wash cycle.

In the direct spray chemical application system 100 (FIG. 3) the frames 302, 304, 306 are protected by external panels, such as the base pan 374 and/or front and side trim panels 372, 380, respectively.

The frames 302, 304, 306 in particular provide designated areas to securely mount the motor, heating element, pump, and other necessary parts. Additionally, the design of the frames 302, 304, 306 is to maximize the useful areas therewithin, which can further allow for better water flow through the tub, ensuring proper cleaning of dishes. The rear cross frame 306 includes two mounting spring frames 308, which help secure and position springs 168 within the direct spray chemical application system 100, allowing them to compress and rebound effectively when force is applied. It is at the mounting spring frames 308 that the cantilever hang eye 172 can be fixedly attached at its lower end. A plumbing rinse bracket 310 can be attached to the front cross frame 306. The plumbing rinse bracket 310 can be a small, typically metal piece that securely holds a pre-rinse spray head in place on a sink or faucet which can be accessed by the operator. The plumbing rinse bracket 310 can act as a mounting point for a pre-rinse spray head, keeping it stable and directed where needed. The plumbing rinse bracket 310 can be used in commercial kitchens to efficiently pre-rinse dishes before placing them in the chamber of the dishwasher. The plumbing rinse bracket 310 can be adjustable to allow for different spray head positions depending on the sink setup.

The frames 302, 304, 306 can further be attached to external legs 312 that are located at each of their lower four corners. As mentioned above, the external legs 312 can come with adjustable bullet feet 376 (FIG. 3), which can be turned using a pair of channel locks or by hand if the unit can be raised safely.

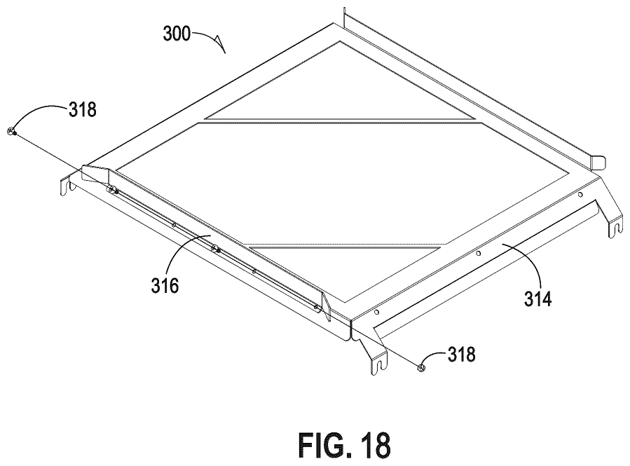

As shown in FIG. 18, a rack guide 314 acts as a structural support system within the rack, helping to properly position dishes and ensure they stay in place during the wash cycle, preventing them from shifting or falling over, while also allowing water to flow freely around them for optimal cleaning. Essentially, the rack guide 314 guides the placement of dishes on the rack for efficient washing. The tines and raised sections (e.g., the M200 f-guide 316 which is fastened in place using screws 318) of the rack guide 314 can help hold dishes securely in place, preventing them from moving around too much during the wash cycle. The design of the rack guide 314 can further allow water to reach all surfaces of the dishes by directing the water spray from the wash arms 112 and rinse arms 116. The rack guide 314 can be adjustable, allowing the operator to customize the space to fit different sized wares. The rack guide 314 can have designated areas for different types of dishes like cups, plates, and utensils, helping to load the direct spray chemical application system 100 efficiently.

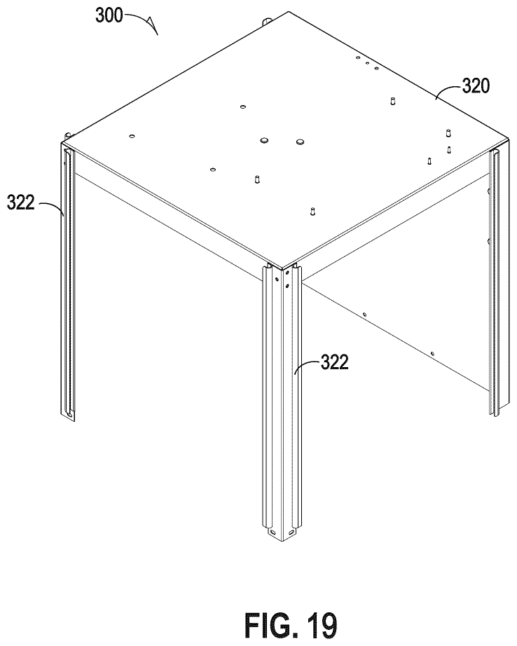

As shown in FIG. 19, the structural subsystem 300 includes an upper half (also referred to as the “chamber”) which comprises a main chamber member 320 and two chamber legs 322. The dishwasher chamber 320, 322 refers to the main internal compartment within the dishwasher where dishes are loaded and where the water and detergent mix circulate during the wash cycle, essentially acting as the “washing area” for the wares. The dishwasher chamber 320, 322 is where the spray arms 112, 116 rotate to distribute the cleaning solution over the dishes. The dishwasher chamber 320, 322 holds the dishes and allows the water to flow around them, facilitating the cleaning process by spraying water and detergent onto the surfaces of the dishes. The dishwasher chamber 320, 322 also includes the nozzle systems 200 described above, as well as the drain at the bottom to remove dirty water.

In the direct spray chemical application system 100 (FIG. 3) the a main chamber member 320 and two chamber legs 322 are protected by external doors, such as front and side door 360, 362, respectively. The direct spray chemical application system 100 can have a dedicated compartment within the dishwasher chamber 320, 322 near the front door 360 where an inlet to the one or more of the chemical dispensers is placed, to allow for refilling same at a location that still feeds into the drain.

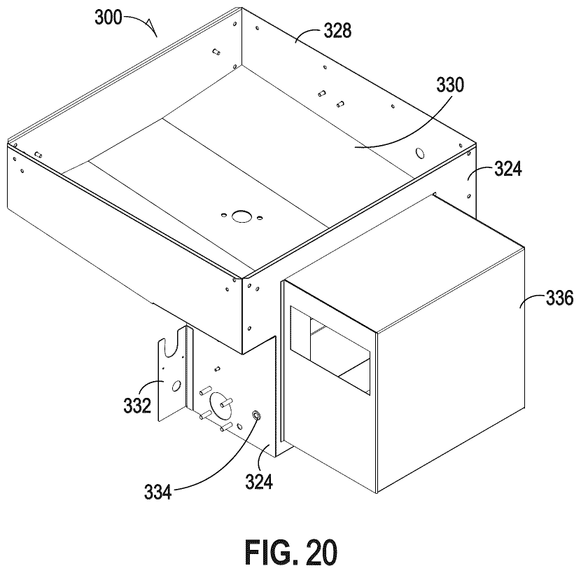

As mentioned above, the tub can include a tank. So, in the example shown in FIG. 20, a tank is comprised of a tank wrap 324, a tank front 326, a tank back 328, and a false bottom 330. The tank wrap 324 wraps from the tank front 326 to the tank back 328 to form an enclosure, with enough room for the false bottom 330 to be placed thereabove.

A conduit bracket 332 is attached to the tank wrap 324 at a lower front portion of same. The conduit bracket 332 is a mounting device used to securely hold electrical conduit (a tube used to protect electrical wires) near the wash tank 324, 326, 328 in place, allowing the conduit to run along a desired path while providing support and preventing damage to the wires inside. Essentially, the conduit bracket 332 acts as a support system for the conduit to keep it from sagging or shifting position. The conduit bracket 332 clamps onto the conduit and attach it to a structural element. The conduit bracket 332 is made of a metal or a plastic.

A thermostat fitting 334 is also placed within the front lower portion of the tank wrap 324. The thermostat fitting 334 is a connection point on a heating or cooling system where the thermostat wire is attached, essentially acting as the communication link between the thermostat and the direct spray chemical application system 100, allowing the thermostat fitting 334 to signal when to turn the heating or cooling on or off based on the desired temperature setting. The thermostat fitting 334 provides a secure connection for the thermostat wires to send signals to the direct spray chemical application system 100 to control the temperature, such as in the wash tank 324, 326, 328. The thermostat fitting 334 can, in some embodiments, be found on the thermostat itself, where the wires from the direct spray chemical application system 100 are attached, which wires may or may not be fed through the conduit bracket 332. The thermostat fitting 334 is an accurate temperature regulation by allowing the thermostat to communicate effectively with the heating and cooling system of the dishwasher.

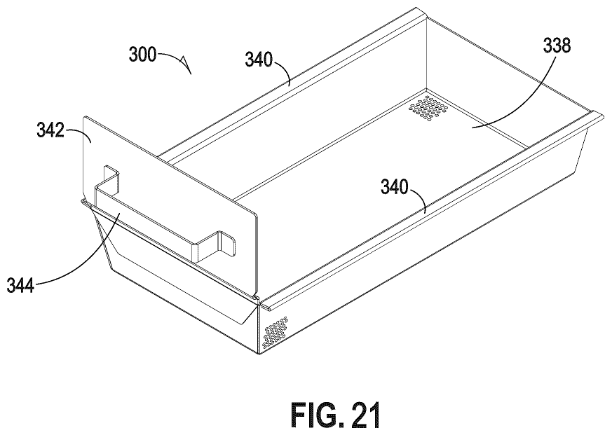

As shown in FIGS. 20-21, a scrap enclosure 336 with a strainer 338 is attached at a lateral location of the tank and below the bottom of the chamber 320, 322. The false bottom 330 is sloped toward the strainer 338. The false bottom 330 is also sloped such that rinse water is allowed to travel toward a cutout in a side of the chamber 320, 322. The strainer 338 is fluidly connected to the drain, which is located upstream thereof, and a wash tank 324, 326, 328, which is located downstream thereof. The strainer 338 filters out soils before passing the rinse water back to the wash tank 324, 326, 328. The strainer 338 comprises strainer guides 340, a handle plate 342, and a strainer handle 344, which together allow the strainer 338 to be slid out like a drawer. The strainer 338 traps food particles and debris during the cleaning cycle, preventing them from recirculating onto clean dishes and clogging the drain, essentially ensuring wares come out clean and protecting the dishwasher pump from damage by catching large food pieces. The strainer 338 catches food remnants and debris to stop them from redepositing on dishes. The strainer 338 is benefitted by regular cleaning to maintain optimal performance and avoid clogs.

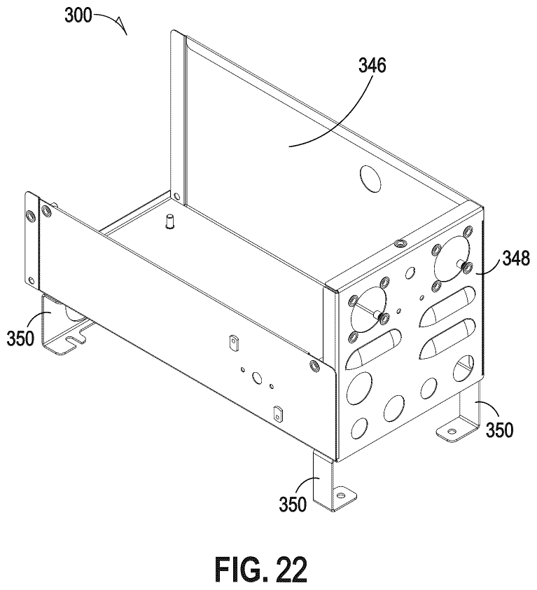

As shown in FIG. 22, the control box is housed with a control box enclosure which includes a body 346, a rear 348, and legs 350. The control box enclosure 346, 348, 350 in the direct spray chemical application system 100 houses an intelligent control that acts as the “brain” of the appliance, managing all the functions and cycles by controlling the water flow, heating elements, motor, and other components based on the selected wash cycle, essentially dictating how the dishwasher cleans the dishes by regulating the timing and sequence of each stage of the wash cycle. The intelligent control allows an operator to choose the appropriate wash cycle (normal, heavy, quick, etc.) based on the level of soiling on your dishes. The intelligent control further regulates the water temperature during the wash cycle. The intelligent control The intelligent control further initiates the motor to start the water circulation and spray arms rotation. The intelligent control further controls the release of detergent at the right time during the wash cycle. The intelligent control further may include sensors to detect the level of soil on dishes, allowing for automatic adjustments to the wash cycle if needed. The intelligent control further initiates the drying phase of the cycle, which can include heating elements to dry dishes. Further aspects of the control system are described in the section titled Control Systems, infra.

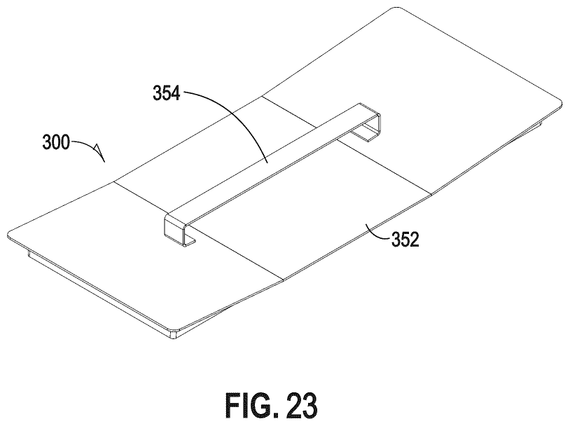

As shown in FIG. 23, a tank cover 352, which can be manipulated with the tank cover handle 354, helps protect the wash tank 324, 326, 328 during operation. The wash tank cover 352 primarily functions to seal the top of a wash tank 324, 326, 328, preventing contaminants from entering the cleaning solution inside, maintaining the cleanliness of the wash liquid, and minimizing the risk of spills or exposure to hazardous chemicals during the cleaning process. The wash tank cover 352 can help contain vapors produced during the cleaning process, especially when using volatile solvents. The wash tank cover 352 also helps to maintain proper temperature within the tank. As evidenced by the wash tank cover handle 354, this particular wash tank cover 352 is equipped with access points for adding cleaning solutions or removing cleaned items to the wash tank 324, 326, 328 while quickly allowing for the prompt return to a sealed environment.

Referring back to FIG. 3, an attic wrap 356 encloses the direct spray chemical application system 100 at its top and acts as a roof to the chamber. The display box 402 is embedded therewithin. Front and side doors 360, 362 attach to the lift arm 144 via side linkages 364 by way of the hex head screws 366. The side doors 362 are further secured in place with hex head bolts 368. The front door 360 can include a decal 370 which indicates an origin of the direct spray chemical application system 100.

As shown in FIG. 24, an electronics subsystem 400 can include a display box 402, with an interactive display 404 and display overlay which allows for user input 406. The display 404 can communicate various aspects of the aforementioned intelligent control. Further aspects of the control system are described in the section titled Control Systems, infra. An interactive dishwasher display 404 monitors the current cycle status of your dishwasher, often including things like remaining time on the cycle, which cycle is selected, and provides any error codes. The interactive display 404 allows letting an operator adjust settings directly on the display, essentially providing real-time feedback about the dishwashing process. The interactive display 404 shows which stage of the washing cycle is currently active (e.g., pre-wash, wash, rinse, drying). The interactive display 404 displays how much time is left until the cycle is complete. The interactive display 404 allows the operator to choose different wash cycles depending on the type of dishes you are cleaning. The interactive display 404 alerts the operator to any issues with the dishwasher operation through specific codes. In some embodiments, the interactive display 404 can integrate with external computers, such as a smartphone with a smartphone app, so that the direct spray chemical application system 100 can be controlled remotely. The interactive display 404 can give notifications when the cycle is finished. As shown in FIG. 25, a control enclosure 408 protects first and second fans 410, 412, for electronics controls 414, which can form part of the overall intelligent control of the system.

Referring back to FIG. 4, it should be mentioned that the electronic subsystems 400 of the direct spray chemical application system 100 can be turned on and off with the power button 418.

Reed switch magnet controls 416 activate a reed switch by creating a magnetic field that attracts the ferromagnetic reeds within the switch, causing them to close together and complete an electrical circuit; essentially, the magnets proximity to the reed switch turns the circuit on or off depending on its position relative to the switch. The reed switch magnet controls 416 magnetize the reeds inside the switch, causing them to attract each other and close the circuit. The reed switch magnet controls 416 do not need to physically touch the door switch 422 to activate the door, and only proximity is required. Front door jumpers 378 are bypasses for the door switch 422. The front door jumpers 378 essentially trick the direct spray chemical application system 100 into thinking the front door 360 is closed even when the front door 360 is not closed, allowing the dishwasher to run despite the door being slightly open. The use of front door jumpers 378 are not always recommended, as they increase the risks for potential water leaks and electrical hazards.

Wire clamps 420 are dispersed throughout the direct spray chemical application system 100 to allow wires and conduits to secure thereto in an organized fashion.

As shown in FIG. 26, a pumping subsystem 500, includes a motor 502. The motor 502 powers the circulation pump, which is responsible for forcefully pushing water through the wash arms 112 and spray arms 116 during the wash cycle and then directing the dirty water into the drain hose during the rinse cycle, effectively cleaning the wares by circulating hot, soapy water around them. The motor 502 drives the rinse pump assembly 504 that moves water throughout the dishwasher, both for spraying on dishes and draining. The motor 502 is located at the bottom of the dishwasher, connected to the pump subsystem 500. The rinse pump assembly 504 is attached to the motor via screw caps 506. The rinse pump assembly 504 includes an inlet 508 and an outlet 510. The motor 502 can change direction of fluids and switch the inlet 508 with the outlet 510 so as to switch between washing and draining cycles.

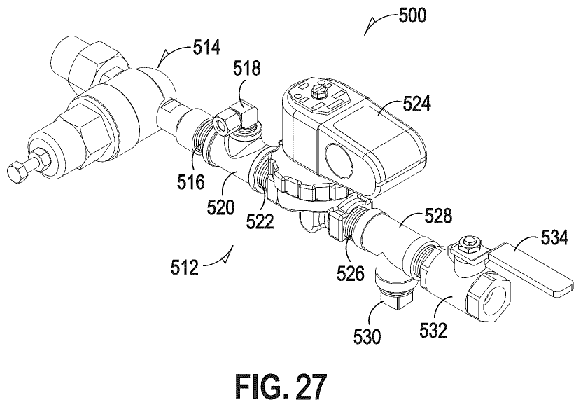

As shown in FIG. 27, a valve subsystem 512 controls the flow of water and air into and out of the direct spray chemical application system 100. The first valve body 514 can be a check valve that prevents dirty drain water from flowing back into the dishwasher. The first valve body 514 can be attached to the rinse pump assembly 504 and can automatically open and closes the wash and drain ports at the end of each cycle.

The first valve body 514 is attached to a first nipple 516, which is itself attached to a pipe tee 520. At the perpendicular portion of the pipe tee 520, there is a compression elbow 518. The compression elbow 518 is a fitting that allows changing the direction of a pipe flow by 90 degrees while connecting it to a main pipe branch, using a compression mechanism that creates a tight seal without the need for soldering or special tools. The compression elbow 518 creates a 90-degree bend in a pipe while connecting it to another pipe at a branch point. The compression elbow further uses a compression sleeve or ferrule that tightens against the pipe to create a leak-proof seal when the nut is turned. The compression elbow 518 is further connected to a second nipple 522 which in turn is attached to a solenoid valve 524.

The solenoid valve 524 is an electrically controlled valve that regulates the flow of water through the dishwasher. The solenoid valve 524 is an electromechanical device that has a coil of wire called a solenoid, which creates a magnetic field when energized. This magnetic field either attracts or repels a plunger, which opens or closes the solenoid valve 524. The solenoid valve 524 is further attached to a third nipple 526, which in turn is attached to a brass tee 528 with a plug 530. The brass tee 528 in turn is attached a second valve body 532.

The second valve body 532 controls the flow of hot water into the dishwasher. The second valve body 532 is located inside the dishwasher. The valve handle 534 can influence the flow rate and/or the temperature of the water through the valve subsystem 512, depending on the application.

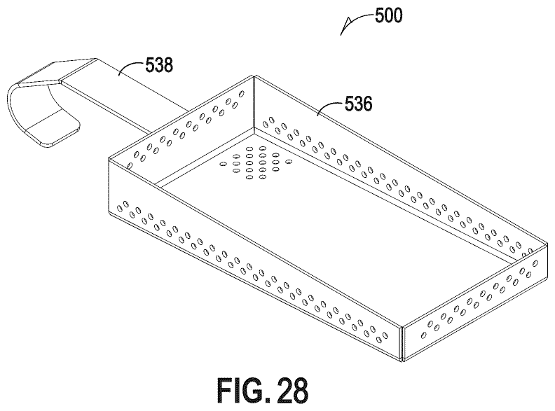

As shown in FIG. 28, the pump strainer 536 includes a handle 538. The pump strainer 436 is a device that filters out large debris and contaminants from a fluid stream before it reaches the rinse pump assembly 504, essentially protecting the rinse pump assembly 504 from damage by preventing large particles from entering and clogging its internal components like the impeller. The pump strainer 536 acts as a coarse filter to safeguard the functionality of the rinse pump assembly 504 by removing larger particles like rust, loose weld metal, or debris. The pump strainer 536 uses a mesh or perforated screen to trap debris, as shown. The pump strainer 536 is installed on the suction side of the pump. The pump strainer 536 prevents pump damage, reduces maintenance needs, and ensures smooth operation.

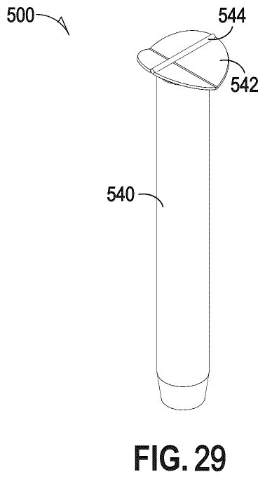

As shown in FIG. 29, a standpipe 540 is included in the tub. The standpipe 540 is a vertical pipe with a lid 542 and a handle 544. The standpipe 540 acts as an elevated drain point for the dishwasher, preventing wastewater from flowing back into the appliance by providing a higher entry point into the drain line, typically connected near the top of the standpipe. Essentially, the standpipe 540 helps ensure proper drainage and prevents potential backflow issues. The standpipe 540 connects to a dishwasher drain hose at the top of the standpipe. The standpipe 540 can be just a part of the overall drain system, and in commercial instances, can be installed alongside a P-trap to prevent sewer gases from the premises.

Referring back to FIG. 5, a wash pump 546 can, but is not limited to, circulating water within the washing machine during the wash cycle, essentially pushing the soapy water through the wares to clean them effectively. The wash pump 546 can also be used to drain the water out of the direct spray chemical application system 100 once the wash cycle is complete by reversing its direction depending on the machine design. The wash pump 546 moves water from the bottom of the tub, allowing the water to be sprayed onto the wares and then recirculated throughout the wash cycle.

Referring now to FIG. 7, the wash pump 546 is located at the bottom of the direct spray chemical application system 100, connected to a drain hose, fluidly connected to both an inlet pipe 548 from the chamber and an outlet pipe 550 to the wash tank 324, 326, 328. First and second heating elements 552, 554 are responsible for heating the water used during the wash cycle, ensuring it reaches the proper temperature to effectively clean dishes, and can also be used to heat air during any drying cycle(s) to help dry dishes thoroughly. Essentially, the first and second heating elements 552, 554 are the components that provides the heat needed for both cleaning and drying dishes within the dishwasher. The first and second heating elements 552, 554 are found at the bottom of the dishwasher tub, within the air gap enclosure 558. first and second heating elements 552, 554 heat the water to a specific temperature based on the selected wash cycle.

### Warewashing Example Configurations & Results

In some embodiments, a series of wares can be sprayed with a first chemistry, a commercially-available caustic detergent with threshold polymer, from top nozzles in the machine with approximately 23 grams of product or 700 ppm chemistry. This direct application of the chemistry was compared across various temperature conditions at the 700 ppm concentration applied to the wares. The first series of wares on the left were washed using 17 gpg sump water sprayed at 153° F. The second series of wares were washed at a lower temperature of 133° F. The third series of wares were washed at the lowest temperature 103° F. Each of the three series of wares were cleaned with no substantial differences despite the variations in water temperature. The results at the end of the wash cycle indicated that it only took 166 ppm of an Active Caustic concentrated cleaning composition (equated to 700 ppm of the first chemistry) to achieve superior cleaning efficacy with the direct application of the chemistry regardless of temperature and while using hard water, compared to even 10,000 ppm of chemistry applied through a sump dilution in the dishmachine as is conventionally performed in dishmachines.

In some embodiments, a commercially-available caustic detergent with chelant shows better results with a completely clean series of wares when washed with 5 gpg of high temperature water between 150-160° F. The second chemistry thus appears to remove more soil than the first chemistry. Wares cleaned by a typical sump filled cleaning composition do not adequately remove staining and soils from cleaned substrates even at high temperature between 150-160° F.

In some embodiments, wares sprayed with a higher amount of the first and second chemistries show a comparable efficacy of soil removal regardless of the type of water used. However, the wares treated with the lower amount of first and second chemistries show slightly less soil removal. The results indicate that the higher amount of chemistry was more effective to clean soil stains regardless of the type of water used in the dishmachine. This is a convincing when compared to prior examples demonstrating the state of the art where 10,000 ppm chemistry was required to remove the stains from the times and in these results 200 ppm or less were required.

In some embodiments, a series of stained wares can be washed with approximately 17 gpg of water at a high temperature between 150-160° F. using 0.85 grams of the first chemistry directly sprayed onto the wares for various wash cycle times in the dishmachine. Each series of wares can be sprayed with 0.85 grams of the first chemistry and washed for various cycle times including 45 seconds, 30 seconds, 15 seconds, 5 seconds or 1 second of wash time. Each ware can dwell within the wash cycle after it was directly sprayed with chemistry for 5 seconds followed by a wash with approximately 17 gpg sump water, and then can be rinsed for about 15 seconds. The soil removal is effective regardless of the wash cycle time—demonstrating a critical improvement of the methods described herein in that the direct application of the chemistry can reduce the cycle time for the subsequent wash cycle. These results showed that the application of the first chemistry can be effective in soil removal independent of water hardness and wash cycle time as each series of wares were equally clean.

The wares can also be subject to water at a low temperature between 110-120° F. and also 17 gpg water used. The soil removal with as little as 0.85 grams of the first chemistry directly applied can prove to be effective independent of water temperature, water hardness, and wash cycle time.

Wares can also be stained with various soils. Soils on the wares can include, but are not limited to including stains from oils and/or food products. The wares can then be separated into groups. Each of the series of wares can be washed in a dishmachine with 17 gpg water from the sump at a high temperature between 150-160° F., undergo 3 wash cycles, and 3 of the groups of wares were sprayed directly with 1.6 grams of the first chemistry, the second chemistry, and a third chemistry, which is a commercially-available low alkalinity and enzyme containing detergent, on each of the wares within the dishmachine. The sprayed wares can be left to dwell for 5 seconds, and this can be followed by an about 45 second wash.

According to some embodiments, a group of food stained wares can be washed and sprayed directly with about 1.6 grams of the third chemistry during the wash cycle. The results indicated that for the wares, there is a substantial amount of soil removal.

According to some embodiments, a group of wares can be washed and sprayed with about 1.6 grams of the first chemistry. These wares show a higher efficacy rate of soil removal and cleaner wares than those sprayed with the third chemistry, suggesting that the first chemistry appears to be more effective than the third chemistry.

According to some embodiments, another group of wares stained with food can be were washed and sprayed with about 1.6 grams of the second chemistry before the wash cycle. Overall, the wares cleaned with the second chemistry appeared to have better results and higher efficacy of food soil removal than the wares cleaned with the first and third chemistries.

According to some embodiments, a series of stained wares can be placed in the dishmachine and treated with about 17 gpg water in the sump at high temperature between 150-160° F. with four different types of concentrated cleaning or rinsing compositions including the first chemistry, the second chemistry, the third chemistry, and a fourth chemistry, which is a commercially-available low caustic alkalinity detergent that does not require the use of personal protective equipment (PPE) (or lessened PPE requirements). The first, second, and third chemistries are the same commercially-available detergents described in prior embodiments.

For example, the first, second, third, and fourth chemistries can be delivered as 2000 ppm chemistry from the sump (diluted into the sump), and in the bottom grouping, the first chemistry, the second chemistry, the third chemistry, and the fourth chemistry were directly sprayed in the amount of 0.85 g (100 ppm) onto each ware. After the chemistry was applied in both groups, each ware can be left for 5 seconds to dwell, followed by a 45 second wash cycle. As displayed by the results, the direct spray (bottom row) was more effective at a higher pH, particularly for the first and second chemistries. The results suggest that regardless of the chemistry used, the sump solution is not as effective as directly spraying the wares for soil removal while dosing a lower concentration of the chemistry.

There is increased ionic strength supported by the increased performance of each concentrated cleaning or rinsing composition. The higher pH used when each chemistry is sprayed directly onto the ware correlates to cleaner wares. This is especially true with respect to the second chemistry and the first chemistry. Wares washed with chemistry in the sump will not show the same level of effectiveness regardless of pH.

According to some embodiments, a series of stained wares can be tested with different concentrations of Caustic (NaOH) solutions or Ash (Sodium Carbonate) Solutions at varying pH levels in order to compare which solution at different pH levels was most effective for soil removal. 5 of the series of wares can be sprayed with 0.1-5% of Caustic Solution. Each ware can be directly sprayed with 0.85 g of Caustic Solution and then can be washed with about 17 gpg water in the sump at high temperature between 150-160° F. After the Caustic Solution is directly sprayed on each ware, the wares can be left to dwell for five seconds and followed by 45 second wash cycle. The remaining 2 series of wares can be sprayed with 5% or 10% of Ash Solution also at varying pH levels undergoing the same procedure in the dishmachine as outlined above. The results show that the Caustic Solution with the highest pH levels, particularly 13.0, can yield the best soil removal as opposed to the Caustic Solutions with lower pH ranges or the Ash Solution.

According to some embodiments, a series of wares can be tested with the first chemistry applied directly to the wares in the dishmachine. Each series of wares can also be washed with either no food soil in the sump, 2000 ppm of Food Soil in the sump and 8125 ppm Food Soil in the Sump. The wares can be washed with 17 gpg of Sump water at a high temperature. After the wares were sprayed with the first chemistry, the wares were left to dwell for 5 seconds, the wares were then washed for 45 seconds and rinsed for 15 seconds. Independent of the food soil concentration in the sump, the soil removal can still prove effective when each ware was directly sprayed with the first chemistry.

According to some embodiments, multiple stained wares can be subjected to low temperature between 110-120° F., about 17 gpg water in the sump with hot point food soil in the sump. Each plate can undergo a 10 second flush, a five second pause, a 5 second direct application spray of the first chemistry, and 35 second wash cycle. The results indicate that the hot point food soil in the sump aids surface contact of the applied chemistry and is therefore more effective than no food soil used to clean the wares.

According to some embodiments, a series of wares can be stained with different foods.

Each ware can be colored according to the type of food. Each series of wares can be washed with about 17 gpg water in the sump at a high temperature between 150-160° F. treated with the third chemistry as described below, were left to dwell for 5 seconds and then can be followed by a 45 second wash cycle. The first of the series of wares can be cleaned with the third chemistry at 2000 ppm within the sump and followed by 3 wash cycles. The second series of wares can be sprayed directly with about 1.6 grams on each ware for a total of about 240 ppm to the sump of the third chemistry and can be followed by 1 wash cycle. The third series of wares were sprayed directly with about 1.6 grams on each ware for a total of about 240 ppm to the sump for each run of the third chemistry and was followed by 3 wash cycles (providing 240 ppm for first 1 wash cycle, cumulatively 480 ppm for 2 wash cycles, and 720 ppm for 3 wash cycles). Overall, the third series of wares sprayed directly with about 1.6 grams of the third chemistry and washed 3 times (720 ppm) may be the most effective for soil removal regardless of the type of food stain.

According to some embodiments, a series of wares can be contacted with an active caustic solution. The first series of wares can be placed in a dishmachine and washed with about 17 gpg water at a high temperature of about 158° F. The left series of the wares can be treated with 6000 ppm of the first chemistry and delivered to the wares via a sump solution. This chemistry equates to about 1425 ppm of active caustic. The right series of the wares can be contacted using the same process with about 7000 ppm of the first chemistry, which is about 1675 ppm of active caustic. The results following the washing cycle show that the wares treated with a higher amount of active caustic cleaned the tea stains better as would be expected using the state of the art dishwashing method where soil removal is enhanced with an increased concentration of chemistry applied through the sump of the dishmachine.

In similar embodiments, stained wares can undergo a similar process to those above. The first half of wares were contacted with about 500 ppm of active caustic solution and the second half of the wares were contacted with about 2000 ppm of active caustic solution during the wash cycle. Two sets of wares in each group can undergo this treatment with about 0 gpg sump water, two were washed with about 5 gpg sump water, and the last two can be washed with about 17 gpg sump water. The water used can once again be at the same high temperature of about 158° F. The results following the wash cycle can indicate that those wares treated with about 2000 active caustic clean stains more effectively than those treated with about 500 ppm active caustic regardless of the amount of water used as would be expected using the state of the art dishwashing method where soil removal is enhanced with an increased concentration of chemistry applied through the sump of the dishmachine.

In similar embodiments, two series of wares can be treated utilizing the same process at a lower temperature of about 100° F. The first series of wares can be treated with about 2000 ppm of active caustic in the sump water, and were washed with 17 gpg water at a low temperature of 125° F. The second series of wares were washed with the same concentration of active caustic and water, but at a lower temperature of 100° F. Following the wash cycle, the results indicate that the wares can be washed at about 125° F. were cleaner than those washed at 100° F., using the same concentration and amount of water.

The results suggest that the higher concentration of active caustic, the better results for soil removal under both high and low temperatures in the dishmachine.

In similar embodiments, a series of stained wares were washed in a dishmachine using three different concentrations of active caustic solutions at different pH levels employing the direct contact of the chemistry instead of dilution within the dishmachine sump. Each set of the stained wares were washed at a high temperature between 150-160° F. with about 5 gpg water from the sump and can be directly sprayed with about 56 grams of caustic per cycle.

In similar embodiments, a series of wares can be directly sprayed with 1% of Caustic solution with a concentration pH of about 12.9 providing about 20 ppm of active caustic. The end of the wash cycle as outlined above demonstrates that the wares can be extremely clean with dosing not more than 56 grams of chemistry. Based on the cleaning efficacy achieved in the first application of the about 1% caustic solution, the chemistry concentration can be lowered to assess for efficacy at a lower concentration with the direct application of the chemistry.

In similar embodiments, a series of wares can be washed with the lower concentration, an about 0.5% of Caustic Solution with concentration pH of about 12.7 providing about 10 ppm of active caustic solution directly applied to wash the wares. The wares result in similar effectiveness of removing the stains.

In similar embodiments, a still further reduced concentration of caustic solution can be based on the cleaning efficacy achieved in the applications of the 1% caustic solution and 0.5% caustic solutions. In other words, the same procedure can be conducted on a series of wares with about 0.25% of Caustic solution at a pH of about 12.5 providing no more than 5 ppm of active caustic directly applied to the wares. These wares were the least clean of the three groups, suggesting a threshold for a caustic only solution employing the direct contact cleaning method should be greater than 5 ppm, such as at least about 10 ppm of Caustic solution to achieve effective cleaning results for the stained wares.

According to some embodiments, a series of wares representing the most challenging soil to remove can be contacted with the first chemistry. The wares can be individually arranged in a rack for a dishmachine using about 17 gpg water at a low temperature of about 100° F. This example uses about 17 gpg water and low temperature to provide challenging water conditions and evidence that there is beneficially performance benefits of the methods described herein while using very little actives in comparison to the actives used in a sump. Even under most challenging soil conditions and using 17 gpg hard water and low temperature, the results show significant improvement over the state of the art, i.e., the results are approximately equivalent to a sump dosing of about 7000 ppm of the first chemistry (approximately 1650 ppm active caustic) using the state of the art dishwashing methods.

### Control Systems

The present application may comprise one or more electronic controls 414 for regulating water recirculation, water reuse, and/or water levels in the wash tank 324, 326, 328 during the wash cycle.

In an embodiment, the one or electronics controls 414 comprises an industrial control system. Any suitable industrial control system may be used according to the present application, including but not limited to programmable logic controllers (PLCs), distributed control systems (DCS), and/or supervisory control and data acquisition (SCADA).

In a preferred embodiment the industrial control system comprises one or more PLCs. PLCs may comprise a power supply and rack, central processing unit (CPU), memory, and a plurality of input/output (“I/O”) modules having I/O connection terminals. PLCs are ordinarily connected to various sensors, switches, measurement devices, interactive displays 404 that provide inputs to the PLC and to relays or other forms of output to control the controlled elements. The one or more PLCs according to the present application may be modular and/or integrated types. In a preferred embodiment, the PLC receives inputs corresponding to two conditions: a low level/low voltage condition and a high level/high voltage condition. In this embodiment, the low voltage condition is head pressure created by water in the wash wheel and the input device for this condition is a pressure transducer. Further, in this embodiment, the high voltage condition is a plurality of mechanical and/or chemical signals, particularly activation of the cold water fill valve, activation of the hot water fill valve, the beginning of the ULL fill step, or the beginning of the normal fill step. In an embodiment, the output signal comprises one or more mechanisms for controlling direct spray locations, fluids to be dispensed, etc. as described herein, e.g. a plurality of nozzles, a mixture of detergent and/or air, etc.

In a further embodiment, the systems of the present application are alternatively or additionally part of a DCS. In this embodiment, one or more wash machines according to the present application are connected to DCS and maintain continuous communications with operating PCs through, for example, a high speed communication network or bus.

In a still further embodiment, the systems of the present application are additionally controlled via a SCADA system, comprising one or more supervisory computers communicating with, for example, the aforementioned PLCs, remote terminal units (RTUs), a communication infrastructure, and a human-machine interface (HMI).

In an embodiment, the one or more control systems comprises a printed circuit board, including but not limited to a single sided PCB, a double sided PCBs, multilayer PCBs, rigid PCBs, flex PCBs, and/or rigid-flex PCBs. PCBs generally comprise a power source, one or more resistors, one or more transistors, one or more capacitors, one or more inductors, one or more diodes, switches, a quad operational amplifier (op-amp), and/or light emitting diodes (LEDs). In a preferred embodiment a printed circuit board according to the present application comprises a DC/DC converter, a pressure transducer a quad op-amp, two 210 kΩ resistors and two 1.02 kΩ resistors.

Where the one or more control systems comprises memory, the memory includes, in some embodiments, a program storage area and a data storage area. The program storage area and the data storage area can include combinations of different types of memory, such as read-only memory (“ROM”, an example of non-volatile memory, meaning it does not lose data when it is not connected to a power source), random access memory (“RAM”, an example of volatile memory, meaning it will lose its data when not connected to a power source) Some examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, a hard disk, an SD card, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

Further, where the one or more control systems include a power supply, it will be generally understood that the power supply outputs a particular voltage to a device or component or components of a device. The power supply could be a DC power supply (e.g., a battery), an AC power supply, a linear regulator, etc. The power supply can be configured with a microcontroller to receive power from other grid-independent power sources, such as a generator or solar panel.

With respect to batteries, a dry cell battery or a wet cell battery may be used. Additionally, the battery may be rechargeable, such as a lead-acid battery, a low self-discharge nickel metal hydride battery (LSD-NiNM) battery, a nickel-cadmium battery (NiCd), a lithium-ion battery, or a lithium-ion polymer (LiPo) battery. Careful attention should be taken if using a lithium-ion battery or a LiPo battery to avoid the risk of unexpected ignition from the heat generated by the battery. While such incidents are rare, they can be minimized via appropriate design, installation, procedures and layers of safeguards such that the risk is acceptable.

The power supply could also be driven by a power generating system, such as a dynamo using a commutator or through electromagnetic induction. Electromagnetic induction eliminates the need for batteries or dynamo systems but requires a magnet to be placed on a moving component of the system.

The power supply may also include an emergency stop feature, also known as a “kill switch,” to shut off the machinery in an emergency or any other safety mechanisms known to prevent injury to users of the machine. The emergency stop feature or other safety mechanisms may need user input or may use automatic sensors to detect and determine when to take a specific course of action for safety purposes.

The one or more controllers of the present application may further comprise a control circuit box. The control circuit box is preferably water tight. The control circuit box protects the PLC (or other comparable control system), relays, and wire connectors.

In a further embodiment, the one or more control systems are provided as part of a controller kit comprising one or more controller systems, a transducer, pressure tubing, and one or more mechanisms for controlling water levels as described herein, e.g. a plurality of valves, a peristaltic pump, etc.

### Reservoir Level Control Floats

The water level in the reservoir tank is controlled by float sensor 556 or another level sensors which can detect the amount of water in the reservoir. In a preferred embodiment, there are two floats, a low-level float and a high-level float, but there may be three or four floats depending on additional control needed.

The purpose of the low-level float is two-fold: 1) to prevent the reservoir water transfer pump from running dry, and 2) to trigger an automatic partial refill of the tank if needed. The partial refill of the tank feature is particularly beneficial when the apparatus is connected to several washing machines. In that case, the reservoir can be automatically refilled with fresh water up to a certain level so that each machine is ensured to receive water from the reservoir. That is, each machine can receive reservoir water because the reservoir is not allowed to be empty.

The purpose of the high-level float is two-fold: 1) to prevent the reservoir tank from overflowing, either from the drain pump or from the fresh water flow into the reservoir. 2) to trigger the fresh water top-off to stop flowing water into the reservoir.

A mid-level float can be implemented to fill the reservoir to a middle level between the high and low levels. The mid-level float allows the addition of some fresh water but leaves enough room in the reservoir so that the reservoir can receive more reuse water from a machine, thus preventing an empty situation and also allowing for the maximum amount of water reuse and savings.

Laundry machines can be calling for water fill for the wash, bleach, and rinse steps at different times and sometimes simultaneously with other machines need for water. The astute utilization of level sensors and logic can minimize the occurrence of water shortages and maximize the amount of reuse water and time savings achieved by pumping water rapidly from the reservoir tank.

### Water Softener

To further facilitate soil removal efficacy, the system of the present application may be used in conjunction with a water softening device. Water softening mechanisms assist in removing ions, particularly calcium and magnesium ions, from hard water. Ions found in hard water can interfere with the detersive efficacy of a cleaning composition. Any suitable water softening device may be used, for example an ion exchange resin, lime dispensing devices, distillation, reverse osmosis, crystallization, and others. In an embodiment, a water softening device is used together with chelating agents, builders, sequestering agents, and/or water conditioning polymers in a cleaning composition. In an embodiment, the water softening device comprises an ion exchange resin. In a preferred embodiment, the ion exchange resin is a L-2000 XP ion exchange resin.

Each of the aforementioned components and features may be included optionally together with the reservoir tank and pump. One feature may be included with the reservoir tank and pump, or multiple features may be included. The number of features included will depend on the particular application and environment.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 020 | automated cleaning apparatus |
| 022 | shelf |
| 024 | cabinet body |
| 026 | wash tank |
| 030 | upper wash spray arms |
| 032 | lower wash spray arm |
| 034 | ware |
| 036 | rack |
| 038 | lower rinse spray arm |
| 040 | upper rinse spray arm |
| 042 | user interface |
| 044 | controller |
| 046 | chemical dispenser |
| 048 | lower spray points |
| 050 | upper spray points |
| 060 | direct spray system |
| 062 | control board |
| 064A | first pump |
| 064B | second pump |
| 066A | first chemistry |
| 066B | second chemistry |
| 068A | first (upper) nozzle |
| 068B | second (upper) nozzle |
| 070 | fine mist |
| 072 | wash chamber |
| 074A | first additional (lower) nozzle |
| 074B | second additional (lower) nozzle |
| 100 | direct spray chemical application system & plumbing |
| | subsystem(s) |
| 102 | upper hub |
| 104 | lower hub |
| 106 | rotor |
| 108 | primary manifold tube |
| 110A | upper secondary manifold tube |
| 110B | lower secondary manifold tube |
| 112 | wash arm |
| 114 | wash arm nozzle |
| 116 | rinse arm |
| 118 | rinse arm aperture |
| 120 | primary manifold tube bracket |
| 122 | secondary manifold tube mounting plate |
| 124 | secondary manifold tube rinse gasket |
| 126 | lower hub gasket |
| 128 | lower hub adapter |
| 130 | wash arm plug |
| 132 | rinse arm end cap |
| 134 | shaft arm |
| 136 | chemical-resistant plastic washer |
| 138 | seat |
| 140 | retaining ring |
| 142 | O-ring |
| 144 | lift arm |
| 146 | lift arm aperture |
| 148 | mounting spring frame |
| 150 | bushing |
| 152 | yoke |
| 154 | pin |
| 156 | upper hub coupling portion |
| 158 | upper hub nipple |
| 160 | lower hub coupling portion |
| 162 | lower hub nipple |
| 164 | bulkhead to half hose barb fitting |
| 166 | bracket arm |
| 168 | cantilever spring(s) |
| 170 | hook |
| 172 | cantilever hang eye |
| 200 | direct application nozzle subsystem(s) |
| 202 | push-to-connect tube fitting for air and water |
| 204 | adapter |
| 206 | misting nozzle |
| 208 | air fitting |
| 210 | water fitting |
| 212 | threads |
| 214 | aperture |
| 216 | central shaft |
| 218 | mesh |
| 220 | connector |
| 222 | hex head |
| 224 | threads |
| 300 | structural subsystem(s) |
| 302 | leg frame |
| 304 | side frame |
| 306 | cross frame |
| 308 | mounting spring frame |
| 310 | plumbing rinse bracket |
| 312 | tank leg |
| 314 | rack guide |
| 316 | rack M200 f-guide |
| 318 | screw |
| 320 | main chamber member |
| 322 | chamber leg |
| 324 | tank wrap |
| 326 | tank front |
| 328 | tank back |
| 330 | false bottom |
| 332 | conduit bracket |
| 334 | thermostat fitting |
| 336 | scrap enclosure |
| 338 | strainer |
| 340 | strainer guide |
| 342 | handle plate |
| 344 | strainer handle |
| 346 | control box body (wrap) |
| 348 | control box rear |
| 350 | control box leg |
| 352 | tank cover |
| 354 | cover handle |
| 356 | attic wrap |
| 358 | upright cover |
| 360 | front door |
| 362 | side door |
| 364 | side linkage |
| 366 | hex head screw |
| 368 | hex head bolt |
| 370 | decal |
| 372 | front trim panel |
| 374 | base pan |
| 376 | foot |
| 378 | front door jumper |
| 380 | side trim panel |
| 400 | electronics subsystem(s) |
| 402 | display box |
| 404 | interactive display |
| 406 | display overlay and inputs |
| 408 | control enclosure |
| 410 | first fan |
| 412 | second fan |
| 414 | electronic controls |
| 416 | reed switch magnet controls |
| 418 | power button |
| 420 | wire clamp(s) |
| 422 | door switch |
| 500 | pumping subsystem(s) |
| 502 | motor |
| 504 | rinse pump assembly |
| 506 | screw cap |
| 508 | inlet |
| 510 | outlet |
| 512 | valve subsystem |
| 514 | first valve body |
| 516 | first nipple |
| 518 | compression elbow |
| 520 | pipe tee |
| 522 | second nipple |
| 524 | valve solenoid |
| 526 | third nipple |
| 528 | brass tee |
| 530 | plug |
| 532 | second valve body |
| 534 | valve handle |
| 536 | pump strainer |
| 538 | strainer handle |
| 540 | standpipe |
| 542 | standpipe lid |
| 544 | standpipe handle |
| 546 | wash pump |
| 548 | inlet pipe from chamber |
| 550 | outlet pipe to tank |
| 552 | first heating element |
| 554 | second heating element |
| 556 | float sensor |
| 558 | air gap enclosure |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

All publications, including all patents, patent applications and other patent and non-patent publications cited or mentioned herein are incorporated herein by reference for at least the purposes that they are cited; including for example, for the disclosure or descriptions of methods of materials which may be used. Nothing herein is to be construed as an admission that a publication or other reference (including any reference cited in the Background section) is prior art to the invention or that the invention is not entitled to antedate such disclosure, for example, by virtue of prior invention.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The term “surfactant” or “surface active agent” refers to an organic chemical that when added to a liquid changes the properties of that liquid at a surface.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end-user can dilute the concentrate with water or an aqueous diluent to a use solution.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A warewashing system comprising:
a chamber defined by at least one chamber member into which wares to be washed can be loaded;
one or more rinse arms, each comprising a plurality of apertures;
one or more wash arms, each comprising a plurality of wash arm nozzles;
a plurality of direct application nozzles attached at an upper portion of the chamber;
a plurality of direct application nozzles located at a lower portion of the chamber;
a drain located at a bottom of the chamber.

2. The system of claim 1, wherein the chamber includes one or more racks, spokes, or shelves.

3. The system of claim 1, further comprising:
a tank located below the chamber;
a strainer attached at a lateral location of the tank and below the bottom of the chamber; and
a false bottom that is sloped toward the strainer and such that rinse water is allowed to travel toward a cutout in a side of the chamber.

4. The system of claim 1, further comprising a wash tank located below the chamber.

5. The system of claim 1, further comprising a rinse pump located beneath the chamber which delivers water to the one or more rinse arms.

6. The system of claim 1, further comprising a wash pump which delivers water to the one or more wash arms.

7. The system of claim 1, wherein the plurality of direct application nozzles attached at the upper portion of the chamber comprise two rinse nozzles dedicated for dispensing a first chemistry and two wash nozzles dedicated to dispensing a second chemistry.

8. The system of claim 1, wherein the plurality of direct application nozzles attached at the lower portion of the chamber comprise at least one nozzle dedicated to dispensing a first chemistry and at least one nozzle dedicated to dispensing a second chemistry.

9. The system of claim 1, further comprising an intelligent control that is operatively connected to a display that has the ability to receive manual inputs from an operator.

10. The system of claim 1, wherein:
the plurality of direct application nozzles attached at an upper portion and/or the plurality of direct application nozzles attached at a lower portion comprise misting nozzles that each include a push-to-connect tube fitting for air and water, an adapter, and a misting nozzle;
the misting nozzle comprises:
a mesh wrapped around a central shaft; or
a hex head and threads located between the mesh and the hex head;
the push-to-connect tube fitting for air and water comprises threads, and each of the threads of the push-to-connect tube fitting for air and water and the threads of the misting nozzle secure to each end of the adapter; and
the each end of the adapter comprise female threads to receive male threads of the push-to-connect tube fitting for air and water and the misting nozzle.

11. The system of claim 10, further wherein:
the push-to-connect tube fitting for air and water comprises an air fitting and a water fitting in-line and fluidly opposed to one another; and
the air fitting and the water fitting are located upstream of an aperture which delivers the chemistry to the misting nozzle.

12. The system of claim 1, further comprising an intelligent control that is capable of:
determining how long to run the wash cycle based upon a type or an amount of soil located on the wares;
determining where to directly apply chemistries within the chamber by automatically adjusting an angle of at least one of the plurality of direct application nozzles;
adjusting a temperature of the wash water or rinse water based upon a type or an amount of soil located on the wares; and
determining how long to run the wash cycle, where to directly apply chemistries within the chamber, and/or adjusts a temperature of the wash water or the rinse water based upon a type of the ware.

13. The system of claim 1, wherein the plurality of direct application nozzles are stationary and are positioned and angled so as to provide a cone pattern coverage when used in combination with one another.

14. The system of claim 1, where an opening type of the plurality of direct application nozzles correlate with a maximum pump pressure and maximum flow rate of water through the warewashing system.

15. An industrial method for washing wares, the method comprising:
loading a dishmachine with wares;
allowing water to flow into a chamber of the dishmachine through one or more rinse arms or one or more wash arms;
directly applying a chemistry to the wares based upon a sensed position of the wares, wherein the direct application does not dilute the cleaning or rinsing composition in a sump of the dishmachine before contacting the article; and
discarding the wash water into a strainer fluidly attached to a drain located at a bottom of the chamber.

16. The method of claim 15, wherein the washing of wares is automatically started once a sensor senses that a chamber of the dishmachine has been loaded with wares and a door to the dishmachine is fully closed.

17. The method claim 15, further comprising:
using a water softening device to remove calcium and magnesium ions from hard water;
wherein the water is reused in the dishmachine until an undesirable level of foaming within the dishmachine, until a threshold change in cleaning efficacy, and/or until a maximum threshold for total dissolved solid (TDS) within the dishmachine exceeds a level requiring a sump to be dumped and refilled.

18. The method of claim 15, wherein:
the method is free from recirculating water;
the chemistry is a cleaning or rinsing composition that is applied with a contact time of about 1 second to about 15 seconds;
the rinse cycle takes less than thirty seconds; and
wherein the direct application does not dilute the cleaning or rinsing composition in a sump of the dishmachine before contacting the article.

19. The method of claim 15, further comprising:
pre-soaking the wares before applying the chemistry; or
priming the rinse pump or the wash pump;
wherein the cleaning or rinsing composition is a detergent, a rinse aid, or a combination thereof.

20. The method of claim 15, wherein:
the cleaning or rinsing composition is dosed at a total concentration less than a cleaning or rinsing composition applied as diluted chemistry of the dishmachine with improved cleaning or rinsing efficacy to methods employing the greater concentration of the diluted composition; or
wherein the cleaning or rinsing composition applied directly to the articles are a concentrated chemistry having a concentration at least about 2 times to about 400 times greater percentage of active ingredients than a concentration of actives of the same cleaning or rinsing composition when applied as diluted chemistry of the dishmachine.
